(19) United States
(12) Patent Application Publication
(10) Pub. No.: US 2025/0180137 A1
(43) Pub. Date: Jun. 5, 2025

(54) SOLENOID, DAMPING FORCE ADJUSTMENT MECHANISM, AND DAMPING FORCE ADJUSTABLE SHOCK ABSORBER

(71) Applicant: Hitachi Astemo, Ltd., Hitachinaka-shi, Ibaraki (JP)

(72) Inventors: Milton MUZVIDZIWA, Hitachinaka-shi, Ibaraki (JP); Koichi YAMAKA, Hitachinaka-shi, Ibaraki (JP); Yohei KATAMAYA, Hitachinaka-shi, Ibaraki (JP); Hiroshi YAMAGAI, Hitachinaka-shi, Ibaraki (JP); Ryuichi SUKA, Hitachinaka-shi, Ibaraki (JP)

(21) Appl. No.: 18/842,996

(22) PCT Filed: Apr. 26, 2023
(86) PCT No.: PCT/JP2023/016377

§ 371 Date: Aug. 30, 2024

(30) Foreign Application Priority Data
Jun. 10, 2022 (JP) 2022-094354

(51) Int. Cl. F16K 31/06; F16F 9/34

(52) U.S. Cl. CPC F16K 31/0675; F16F 9/34; F16F 2222/12

(57) ABSTRACT

A solenoid includes a coil, a housing, an armature, an anchor, and a cover member. The coil is wound annularly, and is configured to generate a magnetic force in reaction to power supply. The armature is provided movably in a direction of a winding axis of the coil, and is made of a magnetic body. The anchor is provided on one side in a movement direction of the armature. The housing is opened on one axial end side. The cover member covers the coil, and is configured to establish a magnetic circuit. The cover member is formed by pressing a plate-like member having an even thickness. The cover member is formed using a plurality of differently shaped members (a first member and a second member).

### TECHNICAL FIELD

The present disclosure relates to, for example, a solenoid, a damping force adjustment mechanism, and a damping force adjustable shock absorber.

### BACKGROUND ART

Vehicles such as four-wheeled automobiles are equipped with shock absorbers (dampers) between the vehicle body (sprung) side and each wheel (unsprung) side. One known example of such shock absorbers of vehicles is a damping force adjustable hydraulic shock absorber that variably adjusts a damping force according to the running condition, the behavior of the vehicle, and/or the like. The damping force adjustable hydraulic shock absorber constitutes a semi-active type suspension of the vehicle.

The damping force adjustable hydraulic shock absorber variably adjusts the generated damping force by, for example, adjusting the valve-opening pressure of a damping force adjustment valve using a damping force variable actuator. For example, a solenoid is used as the damping force variable actuator. Then, for example, PTL 1 discloses an electromagnetic valve including a magnetic flux transfer member interposed between a yoke and a stator.

### CITATION LIST

### Patent Literature

PTL 1: Japanese Patent Application Laid-Open No. 2012-117585

### SUMMARY OF INVENTION

### Technical Problem

On the other hand, a cover member (a covering member) establishing a part of a magnetic circuit of the solenoid and serving as a cover for internal components of the solenoid including a coil is required to be designed to avoid magnetic saturation to achieve a reduction in the axial length and securement of a thrust force at the same time. As a result, the cover member has a complicated shape with a partial thickened portion. Then, forming the cover member by cutting to acquire this shape leads to an increase in the cutting allowance extracted from the material, thereby reducing the yield and increasing the material cost. Further, the productivity is also impaired. Further, in a case where a pure iron-based soft magnetic material excellent in soft magnetic property is used as the cover member, the cutting workability is impaired because this material is soft metal.

An object of one aspect of the present invention is to provide a solenoid, a damping force adjustment mechanism, and a damping force adjustable shock absorber capable of ensuring the performance and improving the productivity at the same time.

### SOLUTION TO PROBLEM

One aspect of the present invention is a solenoid, a damping force adjustment mechanism, or a damping force adjustable shock absorber including a coil wound annularly and configured to generate a magnetic force in reaction to power supply, a mover provided movably in a direction of a winding axis of the coil and made of a magnetic body, a stator provided on one side in a movement direction of the mover, a containing member containing the mover therein and opened on one axial end side, and a cover member configured to establish a magnetic circuit and covering the coil. The cover member is formed by pressing a plate-like member having an even thickness.

Another aspect of the present invention is a solenoid, a damping force adjustment mechanism, or a damping force adjustable shock absorber including a coil wound annularly and configured to generate a magnetic force in reaction to power supply, a mover provided movably in a direction of a winding axis of the coil and made of a magnetic body, a stator provided on one side in a movement direction of the mover, a containing member containing the mover therein and opened on one axial end side, and a cover member configured to establish a magnetic circuit and covering the coil. The cover member is formed using a plurality of differently shaped members.

According to the aspects of the present invention, the performance can be ensured and the productivity can be improved at the same time.

### BRIEF DESCRIPTION OF DRAWINGS

FIG. 1 is a vertical cross-sectional view illustrating a damping force adjustable shock absorber in which a solenoid and a damping force adjustment mechanism according to an embodiment are built.

FIG. 2 is an enlarged cross-sectional view extracting and illustrating the damping force adjustment mechanism and the solenoid illustrated in FIG. 1.

FIG. 3 is an enlarged cross-sectional view extracting and illustrating the solenoid illustrated in FIG. 1.

FIG. 4 is an enlarged cross-sectional view illustrating a solenoid according to a first modification at a position equivalent to FIG. 3.

FIG. 5 is an enlarged cross-sectional view illustrating a solenoid according to a second modification at a position equivalent to FIG. 3.

FIG. 6 is an enlarged cross-sectional view illustrating a solenoid according to a third modification at a position equivalent to FIG. 3.

FIG. 7 is an enlarged cross-sectional view illustrating a solenoid according to a fourth modification at a position equivalent to FIG. 3.

FIG. 8 is an enlarged cross-sectional view illustrating a solenoid according to a fifth modification at a position equivalent to FIG. 3.

FIG. 9 is an enlarged cross-sectional view illustrating a solenoid according to a sixth modification at a position equivalent to FIG. 3.

FIG. 10 is an enlarged cross-sectional view illustrating a solenoid according to a seventh modification at a position equivalent to FIG. 3.

### DESCRIPTION OF EMBODIMENTS

In the following description, a solenoid, a damping force adjustment mechanism, and a damping force adjustable shock absorber according to an embodiment will be described with reference to the attached drawings, citing an example in which they are used for a damping force adjustable hydraulic shock absorber built in a vehicle such as a four-wheeled automobile.

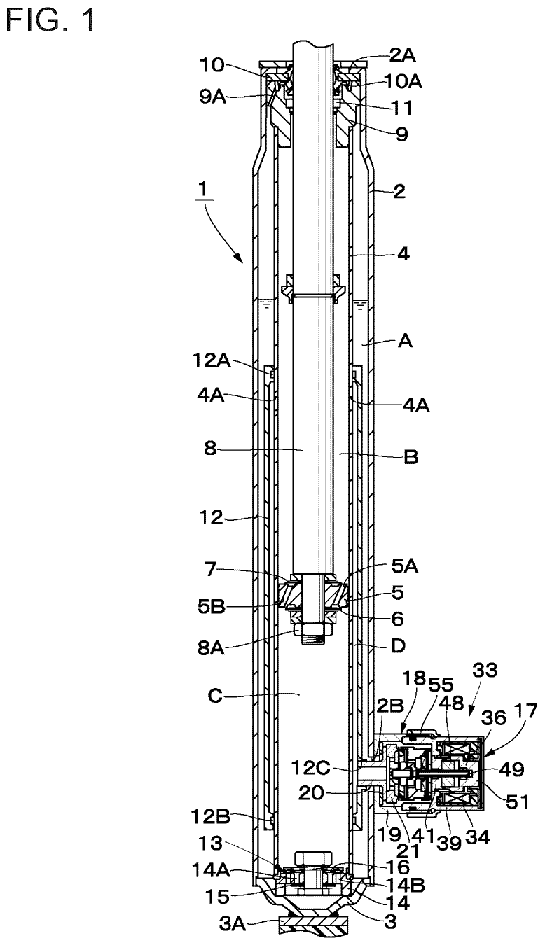

FIGS. 1 to 3 illustrate the embodiment. In FIG. 1, a damping force adjustable hydraulic shock absorber 1 (hereinafter referred to as a shock absorber 1) includes a damping force adjustment mechanism 17 using a solenoid 33 as a driving source. More specifically, the shock absorber 1 as a damping force adjustable shock absorber includes an outer tube 2 and an inner tube 4 as a cylinder, a piston 5, a piston rod 8, and the damping force adjustment mechanism 17.

The shock absorber 1, which is a hydraulic shock absorber, includes the bottomed tubular outer tube 2 forming an outer shell. The lower end side of the outer tube 2 is closed by a bottom cap 3 using a welding method or the like. A radially inward bent crimped portion 2A is formed on the upper end side of the outer tube 2. A rod guide 9 and a seal member 10 are provided between the crimped portion 2A and the inner tube 4. On the other hand, an opening 2B is formed on the lower portion side of the outer tube 2 concentrically with a connection port 12C of an intermediate tube 12. The damping force adjustment mechanism 17 is attached on the lower portion side of the outer tube 2 so as to face the opening 2B. A mounting eye 3A is provided on the bottom cap 3. The mounting eye 3A is attached to, for example, a wheel side of the vehicle.

The inner tube 4 is provided in the outer tube 2 coaxially with the outer tube 2. The lower end side of the inner tube 4 is attached to a bottom valve 13 by being fitted thereto. The upper end side of the inner tube 4 is attached to the rod guide 9 by being fitted thereto. Oil fluid (oil) as hydraulic fluid (working fluid) is sealingly contained in the outer tube 2 and the inner tube 4 serving as the cylinder. The hydraulic fluid is not limited to the oil fluid (the oil), and may be, for example, water with an additive mixed therein.

An annular reservoir chamber A is defined between the inner tube 4 and the outer tube 2. Gas is sealingly contained in the reservoir chamber A together with the oil fluid. This gas may be air in an atmospheric-pressure state, or gas such as compressed nitrogen gas may be used as it. The reservoir chamber A compensates for entry and exit of the piston rod 8. An oil hole 4A is pierced radially at an intermediate position in the length direction (the axial direction) of the inner tube 4. The oil hole 4A establishes constant communication of a rod-side oil chamber B with an annular oil chamber D.

The piston 5 is slidably provided in the inner cylinder 4. The piston 5 is inserted in the inner tube 4, and divides (partitions) the inside of the inner tube 4 into two chambers, the rod-side oil chamber B (a rod-side chamber) and a bottom-side oil chamber C (a bottom-side chamber). A plurality of oil passages 5A and a plurality of oil passages 5B are each formed on the piston 5 so as to be circumferentially spaced apart from each other. The oil passages 5A and 5B can establish communication between the rod-side oil chamber B and the bottom-side oil chamber C.

Then, an extension-side disk valve 6 is provided on the lower end surface of the piston 5. The extension-side disk valve 6 is opened upon exceedance of the pressure in the rod-side oil chamber B over a relief setting pressure used when the piston 5 is slidably displaced upward during an extension stroke of the piston rod 8, and relieves the pressure at this time by releasing it to the bottom-side oil chamber C side via each of the oil passages 5A. The relief setting pressure is set to a higher pressure than a valve-opening pressure used when the damping force adjustment mechanism 17 is set to the hard side.

A compression-side check valve 7 is provided on the upper end surface of the piston 5. The compression-side check valve 7 is opened when the piston 5 is slidably displaced downward during a compression stroke of the piston rod 8, and otherwise is closed. The check valve 7 permits a flow of the oil fluid in the bottom-side oil chamber C through inside each of the oil passages 5B toward the rod-side oil chamber B, and blocks a flow of the oil fluid in the opposite direction therefrom. The valve-opening pressure of the check valve 7 is set to a lower pressure than a valve-opening pressure used when the damping force adjustment mechanism 17 is set to the soft side, and the check valve 7 generates substantially no damping force. Generating substantially no damping force here means a force equal to or weaker than friction of the piston 5 and the seal member 10, and not affecting a motion of the vehicle.

The piston rod 8 extends axially (vertically in FIG. 1) in the inner tube 4. The lower end side of the piston 8 is inserted in the inner tube 4. The piston rod 8 is provided while being fixedly attached to the piston 5 using a nut 8A and the like. The upper end side of the piston rod 8 protrudes out of the outer tube 2 and the inner tube 4 via the rod guide 9. In other words, the lower side (the lower end) of the piston rod 8, which is defined to be one side (one end), is coupled with the piston 5, and the upper side (the upper end) of the piston rod 8, which is defined to be an opposite side (an opposite end), extends out of the inner tube 4 and the outer tube 2. The piston rod 8 may be configured as a so-called double rod with the lower end of the piston rod 8 further extending to protrude outward from the bottom portion (for example, the bottom cap 3) side.

The stepped cylindrical rod guide 9 is provided on the upper end side of the inner tube 4. The rod guide 9 positions the upper portion of the inner tube 4 at the center of the outer tube 2, and also axially slidably guides the piston rod 8 on the inner peripheral side thereof. The annular seal member 10 is provided between the rod guide 9 and the crimped portion 2A of the outer tube 2. The seal member 10 is formed by, for example, baking an elastic material such as rubber to a metallic annular plate including a hole formed at the center thereof for insertion of the piston rod 8. The seal member 10 seals between the piston rod 8 and the outer tube 2 with the aid of sliding contact of the inner periphery of the elastic material thereof with the outer peripheral side of the piston rod 8.

A lip seal 10A is formed on the seal member 10 on the lower surface side thereof. The lip seal 10A serves as a check valve extending so as to contact the rod guide 9. The lip seal 10A is disposed between an oil pool chamber 11 and the reservoir chamber A. The lip seal 10A permits a flow of the oil fluid and the like in the oil pool chamber 11 toward the reservoir chamber A side via a return passage 9A of the rod guide 9, and blocks a flow in the opposite direction therefrom.

The intermediate tube 12 made of a tubular member is arranged between the outer tube 2 and the inner tube 4. The intermediate tube 12 is, for example, attached to the outer peripheral side of the inner tube 4 via upper and lower tubular seals 12A and 12B. The intermediate tube 12 forms therein the annular oil chamber D extending so as to surround the outer peripheral side of the inner tube 4 along the entire circumference thereof. The annular oil chamber D is formed as an oil chamber independent of the reservoir chamber A. The annular oil chamber D is in constant communication with the rod-side oil chamber B via the radial oil hole 4A formed on the inner tube 4. The annular oil chamber D forms a part of a flow passage through which a flow of the hydraulic fluid is generated due to a movement of the piston rod 8. The connection port 12C is provided on the lower end side of the intermediate tube 12. A connection tubular member 20 of a damping force adjustment valve 18 is attached to the connection port 12C.

The bottom valve 13 is provided between the bottom cap 3 and the inner tube 4 at a position on the lower end side of the inner tube 4. The bottom valve 13 includes a valve body 14, a compression-side disk valve 15, and an extensions-side check valve 16. The valve body 14 partitions (defines) the reservoir chamber A and the bottom-side oil chamber C between the bottom cap 3 and the inner tube 4. The compression-side disk valve 15 is provided on the lower surface side of the valve body 14. The extension-side check valve 16 is provided on the upper surface side of the valve body 14. Oil passages 14A and 14B are each formed on the valve body 14 at circumferential intervals. The oil passages 14A and 14B can establish communication between the reservoir chamber A and the bottom-side oil chamber C.

The compression-side disk valve 15 is opened upon exceedance of the pressure in the bottom-side oil chamber C over a relief setting pressure used when the piston 5 is slidably displaced downward during the compression stroke of the piston rod 8, and relieves the pressure at this time by releasing it to the reservoir chamber A side via each of the oil passages 14A. The relief setting pressure is set to a higher pressure than the valve-opening pressure used when the damping force adjustment mechanism 17 is set to the hard side.

The extension-side check valve 16 is opened when the piston 5 is slidably displaced upward during the extension stroke of the piston rod 8, and otherwise is closed. The check valve 16 permits a flow of the oil fluid in the reservoir chamber A through each of the oil passages 14B toward the bottom-side oil chamber C, and blocks a flow of the oil fluid in the opposite direction therefrom. The valve-opening pressure of the check valve 16 is set to a lower pressure than the valve-opening pressure used when the damping force adjustment mechanism 17 is set to the soft side, and the check valve 16 generates substantially no damping force.

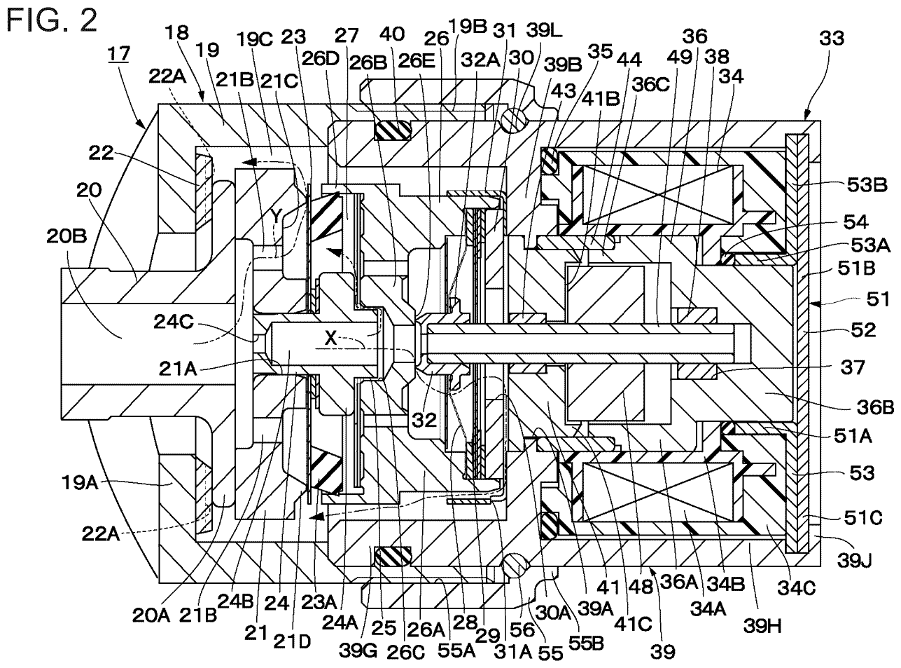

Next, the damping force adjustment mechanism 17 for variably adjusting the generated damping force of the shock absorber 1 will be described with additional reference to FIG. 2 together with FIG. 1.

The damping force adjustment mechanism 17 generates the damping force by controlling the flow of the hydraulic fluid (the oil fluid) generated due to a sliding movement of the piston 5 in the cylinder (the inner tube 4), and also variably adjusts the generated damping force of the shock absorber 1. FIG. 2 illustrates the damping force adjustment mechanism 17 with an armature 48, an actuation pin 49, and a pilot valve member 32 moved to the left side in FIG. 2 according to power supply to a coil 34A of the solenoid 33 from outside (for example, control for generating a hard damping force). In other words, the damping force adjustment mechanism 17 illustrated in FIG. 2 indicates a valve-closed state in which the pilot valve member 32 is seated on a valve seat portion 26E of a pilot body 26.

As illustrated in FIG. 1, the damping force adjustment mechanism 17 is disposed in such a manner that the proximal end side (the left end side in FIG. 1) thereof is interposed between the reservoir chamber A and the annular oil chamber D, and the distal end side (the right end side in FIG. 1) thereof protrudes radially outward from the lower portion side of the outer tube 2. The damping force adjustment mechanism 17 generates the damping force by controlling the flow of the oil fluid from the annular oil chamber D to the reservoir chamber A with use of the damping force adjustment valve 18 (a main valve 23 and the pilot valve member 32). Further, the damping force adjustment mechanism 17 variably adjusts the generated damping force by adjusting the valve-opening pressure of the damping force adjustment valve 18 (the main valve 23 and the pilot valve member 32) by the solenoid 33 used as a damping force variable actuator.

In this manner, the damping force adjustment mechanism 17 generates the damping force by controlling the flow of the hydraulic fluid (the oil fluid) that is generated due to the sliding movement of the piston 5 in the inner tube 4. To fulfill this function, the damping force adjustment mechanism 17 includes the damping force adjustment valve 18 and the solenoid 33. The damping force adjustment valve 18 generates the damping force having the hard or soft characteristic by variably controlling the flow of the oil fluid from the annular oil chamber D to the reservoir chamber A. The damping force adjustment valve 18 of the shock absorber 1 is driven by the solenoid 33.

More specifically, the damping force adjustment valve 18 is a valve configured in such a manner that the valve-opening and closing operations thereof are adjusted by the solenoid 33, and is provided in the flow passage where the flow of the hydraulic fluid is generated due to the movement (extension or compression) of the piston rod 8 (for example, between the annular oil chamber D and the reservoir chamber A). The solenoid 33 adjusts the valve-opening and closing operations of the damping force adjustment valve 18 (the pilot valve member 32 and thus the main valve 23). In this case, the valve-opening pressure of the damping force adjustment valve 18 (the pilot valve member 32 and thus the main valve 23) is adjusted by the solenoid 33 used as the damping force variable actuator, and the generated damping force is variably controlled to the hard or soft characteristic thereby.

Then, the damping force adjustment valve 18 includes a valve case 19, the connection tubular member 20, and a valve member 21. The valve case 19 is generally cylindrically formed, and the proximal end side thereof is fixedly attached to around the opening 2B of the outer tube 2 and the distal end side thereof protrudes from the outer tube 2 radially outward. The connection tubular member 20 is provided in such a manner that the proximal end side thereof is fixed to the connection port 12C of the intermediate tube 12, and the distal end side thereof includes an annular flange portion 20A formed thereon and is arranged inside the valve case 19 with a space generated therebetween. The valve member 21 is in abutment with the flange portion 20A of the connection tubular member 20.

As illustrated in FIG. 2, an annular inner flange portion 19A is formed on the proximal end side of the valve case 19. The inner flange portion 19A extends radially inward. An externally threaded portion 19B is formed on the distal end side of the valve case 19. A lock nut 55 is threadedly engaged with the externally threaded portion 19B. The lock nut 55 is used to join the valve case 19 and a yoke 39 (a one-side tubular portion 39G) of the solenoid 33. An annular oil chamber 19C, which is in constant communication with the reservoir chamber A, is defined between the inner peripheral surface of the valve case 19 and the outer peripheral surface of the valve member 21, and further between the inner peripheral surface of the valve case 19 and the outer peripheral surface of the pilot body 26 and the like. Besides being joined to each other using the lock nut 55, the valve case 19 and the solenoid 33 may be configured in such a manner that, for example, the distal end side of the valve case is crimped to the yoke of the solenoid (configured to use no lock nut).

An oil passage 20B is formed inside the connection tubular member 20. The oil passage 20B has one side in communication with the annular oil chamber D and an opposite side extending to the position of the valve member 21. Further, an annular spacer 22 is provided in a sandwiched state between the flange portion 20A of the connection tubular member 20 and the inner flange portion 19A of the valve case 19. A plurality of radially extending cutouts 22A is provided on the spacer 22. The cutouts 22A serve as radial oil passages for establishing communication between the oil chamber 19C and the reservoir chamber A. In the present embodiment, the damping force adjustment mechanism 17 is configured in such a manner that the cutouts 22A for forming the oil passages are provided on the spacer 22. However, cutouts (grooves) for forming oil passages may be radially provided on the inner flange portion 19A of the valve case 19, instead of the spacer 22.

An axially extending central hole 21A is provided on the valve member 21 at the radially central position thereof. Further, a plurality of oil passages 21B is provided on the valve member 21 around the central hole 21A so as to be circumferentially spaced apart from each other. One side (the left side in FIGS. 1 and 2) of each of the oil passages 21B is in constant communication with the oil passage 20B side of the connection tubular member 20. Further, an annular recessed portion 21C and an annular valve seat 21D are provided on the end surface of the valve member 21 on an opposite side thereof (the right side in FIGS. 1 and 2). The annular recessed portion 21C is formed so as to surround the openings of the oil passages 21B on the opposite side. The annular valve seat 21D is located on the radially outer side of this annular recessed portion 21C. The main valve 23 is seated on and separated from the annular valve seat 21D. Each of the oil passages 21B of the valve member 21 serves as a flow passage through which the hydraulic oil flows between the oil passage 20B of the connection tubular member 20 in communication with the annular oil chamber D and the oil chamber 19C of the valve case 19 in communication with the reservoir chamber A at a flow rate according to the valve lift of the main valve 23.

The main valve 23 is made of a disk valve. The inner peripheral side of the main valve 23 is interposed between the valve member 21 and a large-diameter portion 24A of a pilot pin 24. The outer peripheral side of the main valve 23 is seated on and separated from the annular valve seat 21D of the valve member 21. An elastic seal member 23A is fixedly attached to the outer peripheral portion of the main valve 23 on the back surface side thereof by a method such as baking. The main valve 23 is opened by being separated from the annular valve seat 21D under a pressure on the oil passage 21B side of the valve member 21 (the annular oil chamber D side). As a result, the oil passages 21B of the valve member 21 (the annular oil chamber D side) are brought into communication with the oil chamber 19C (the reservoir chamber A side) via the main valve 23, and the amount (the flow rate) of the hydraulic oil flowing in a direction indicated by an arrow Y at this time is variably adjusted according to the valve lift of the main valve 23.

The pilot pin 24 is formed into a stepped cylindrical shape, and the annular large-diameter portion 24A is provided at an axially intermediate portion thereof. The pilot pin 24 includes an axially extending central hole 24B on the inner peripheral side thereof. A small-diameter hole (an orifice 24C) is formed at one end portion of the central hole 24B (the end portion on the connection tubular member 20 side). One end side (the left end side in FIGS. 1 and 2) of the pilot pin 24 is press-fitted in the central hole 21A of the valve member 21. In this state, the pilot pin 24 sandwiches the main valve 23 between the large-diameter portion 24A thereof and the valve member 21.

An opposite end side (the right end side in FIGS. 1 and 2) of the pilot pin 24 is fitted in a central hole 26C of the pilot body 26. Axially extending oil passages 25 are formed between the central hole 26C of the pilot body 26 and the opposite end side of the pilot pin 24. These oil passages 25 are in communication with a back-pressure chamber 27 defined between the main valve 23 and the pilot body 26. In other words, the plurality of axially extending oil passages 25 is circumferentially arranged on the side surface of the pilot pin 24 on the opposite end side, and circumferential positions of the pilot pin 24 other than that are press-fitted in the central hole 26C of the pilot body 26.

The pilot body 26 is formed as a generally bottomed tubular member, and includes a cylindrical portion 26A and a bottom portion 26B. The cylindrical portion 26A includes a stepped hole formed inside it. The bottom portion 26B closes this cylindrical portion 26A. The central hole 26C is provided on the bottom portion 26B of the pilot body 26. The opposite end side of the pilot pin 24 is fitted in the central hole 26C. A protrusion tubular portion 26D is integrally provided on one end side (the left end side in FIGS. 1 and 2) of the bottom portion 26B of the pilot body 26. The protrusion tubular portion 26D is located on the radially outer side, and protrudes toward the valve member 21 side along the entire circumference. The elastic seal member 23A of the main valve 23 is liquid-tightly fitted to the inner peripheral surface of the protrusion tubular portion 26D, and the back-pressure chamber 27 is defined between the main valve 23 and the pilot body 26 thereby. The back-pressure chamber 27 generates a pressure (an inner pressure or a pilot pressure) that presses the main valve 23 in a valve-closing direction, i.e., in a direction causing the main valve 23 to be seated onto the annular valve seat 21D of the valve member 21.

The valve seat portion 26E is provided on an opposite end side (the right end side in FIGS. 1 and 2) of the bottom portion 26B of the pilot body 26 so as to surround the central hole 26C. The pilot valve member 32 is seated on and separated from the valve seat portion 26E. Further, a return spring 28, a disk valve 29, a holding plate 30, and the like are arranged inside the cylindrical portion 26A of the pilot body 26. The return spring 28 biases the pilot valve member 32 in a direction away from the valve seat portion 26E of the pilot body 26. The disk valve 29 forms a fail-safe valve actuated when the solenoid 33 is in a state that no power is supplied thereto (when the pilot valve member 32 is maximumly separated from the valve seat portion 26E). The holding plate 30 includes an oil passage 30A formed on the central side thereof.

A cap 31 is fittedly fixed at the opening end of the cylindrical portion 26A of the pilot body 26 with the return spring 28, the disk valve 29, the holding plate 30, and the like arranged inside this cylindrical portion 26A. Cutouts 31A are formed on the cap 31 at, for example, positions of four portions circumferentially spaced apart from each other. The cutouts 31A serve as flow passages that allow oil fluid delivered to the solenoid 33 side via the oil passage 30A of the holding plate 30 to flow into the oil chamber 19C (the reservoir chamber A side) as indicated by an arrow X in FIG. 2.

The pilot valve member 32 forms a pilot valve (a control valve) together with the pilot body 26. The pilot valve member 32 is formed into a stepped cylindrical shape. The distal end portion of the pilot valve member 32, i.e., the distal end portion seated on and separated from the valve seat portion 26E of the pilot body 26 has a gradually narrowing tapered shape. The actuation pin 49 of the solenoid 33 is fittedly fixed inside the pilot valve member 32, and the valve-opening pressure of the pilot valve member 32 and thus the valve-opening pressure of the main valve 23 is adjusted according to power supply to the solenoid 33.

In other words, the pilot valve (the pilot body 26 and the pilot valve member 32) as the control valve is controlled according to an axial movement of the actuation pin 49 (more specifically, the armature 48 fixed to the actuation pin 49) of the solenoid 33. A flange portion 32A, which serves as a spring bearing, is formed on the proximal end side of the pilot valve member 32 along the entire circumference thereof. The flange portion 32A forms the fail-safe valve by abutting against the inner peripheral portion of the disk valve 29 when the solenoid 33 is in the state that no power is supplied thereto, i.e., when the pilot valve member 32 is displaced to a fully opened position where the pilot valve member 32 is maximumly separated from the valve seat portion 26E.

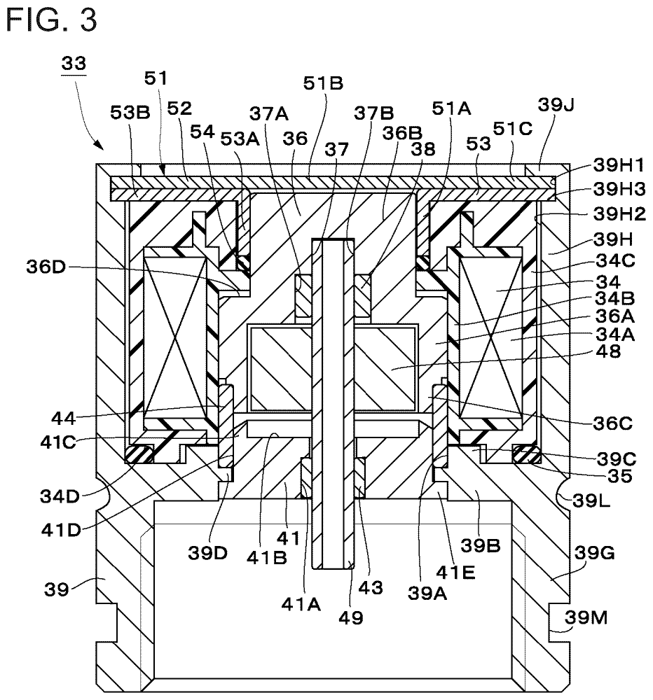

Next, the solenoid 33 constituting the damping force adjustment mechanism 17 together with the damping force adjustment valve 18 will be described with additional reference to FIG. 3 together with FIGS. 1 and 2. In FIG. 3, the reference numerals are indicated with the right side in the horizontal direction in FIG. 2 placed on the upper side. In other words, the horizontal direction in FIGS. 1 and 2 corresponds to the vertical direction in FIG. 3.

The solenoid 33 is built in the damping force adjustment mechanism 17 as the damping force variable actuator of the damping force adjustment mechanism 17. In other words, the solenoid 33 is used in the damping force adjustable shock absorber for the purpose of adjusting the valve-opening and closing operations of the damping force adjustment valve 18. The solenoid 33 includes a molded coil 34, a housing 36 as a containing member (a magnetic member), the yoke 39 as a case member, an anchor 41 as a stator (a fixed core), a cylinder 44 as a joint member (a non-magnetic ring), the armature 48 as a mover (a moving core), the actuation pin 49 as a shaft portion, and a cover member 51.

The molded coil 34 is generally cylindrically formed by winding the coil 34A around a coil bobbin 34B and integrally covering (molding) them with a resin member 34C such as thermosetting resin in this state. An axially or radially outward protruding cable extraction portion (not illustrated) is provided at a circumferential part of the molded coil 34, and an electric wire cable (not illustrated) is connected to this cable extraction portion. The coil 34A of the molded coil 34 is annularly wound around the coil bobbin 34B, and becomes an electromagnet and generates a magnetic field (a magnetic force) in reaction to power supply (energization) from outside via the cable.

A seal groove 34D is formed along the entire circumference on a side surface (an end surface on one axial side) of the resin member 34C of the molded coil 34 that faces the yoke 39 (an annular portion 39B). A seal member (for example, an O-ring 35) is attached in the seal groove 34D. The O-ring 35 liquid-tightly seals between the molded coil 34 and the yoke 39 (the annular portion 39B). Due to this provision, dust containing rainwater or mud water can be prevented from entering a tubular protrusion portion 39C side of the yoke 39 via between the yoke 39 and the molded coil 34.

The coil employed in the present embodiment is not limited to the molded coil 34 including the coil 34A, the coil bobbin 34B, and the resin member 34C, and another coil may also be employed. For example, the employed coil may be configured in such a manner that a coil is wound around a coil bobbin made from an electrically insulating material, and the outer periphery of the coil may be covered with an overmold (not illustrated) formed by molding a resin material (not illustrated) over it (on the outer peripheral side) in this state.

The housing 36 forms the containing member (the magnetic member) provided so as to be arranged on the inner peripheral side of the molded coil 34 (i.e., the inner periphery of the coil 34A). The housing 36 is formed as a lidded cylindrical tubular member from a magnetic material (a magnetic body) such as low-carbon steel or carbon steel for machine structural use (S10C). The housing 36 includes a containing tubular portion 36A as a containing portion, a cover portion 36B, and a small-diameter tubular portion 36C. The containing tubular portion 36A extends in a direction of a winding axis of the molded coil 34 (the coil 34A), and is opened on one end side thereof (the left side in FIG. 2 and the lower side in FIG. 3). The cover portion 36B closes an opposite end side (the right side in FIG. 2 and the upper side in FIG. 3) of the containing tubular portion 36A. The small-diameter tubular portion 36C is located on the opening side (the one side) of the containing tubular portion 36A, and is formed by reducing the diameter of the outer periphery of the containing tubular portion 36A.

The inner periphery of the cylinder 44 is joined to the outer periphery of the small-diameter tubular portion 36C of the housing 36 by brazing. The containing tubular portion 36A of the housing 36 is formed in such a manner that the inner diameter dimension thereof is slightly larger than the outer diameter dimension of the armature 48. The armature 48 is axially movably contained in the containing tubular portion 36A. In other words, the housing 36 is opened on the one axial end side thereof, and the armature 48 is contained therein. The housing 36 (the small-diameter tubular portion 36C) is press-fitted inside the cylinder 44 and is brazed, by which the housing 36 and the cylinder 44 form a pressure container.

On the other hand, the cover portion 36B of the housing 36 is formed integrally with the containing tubular portion 36A as a lidded tubular member that closes the containing tubular portion 36A from an opposite axial side. The cover portion 36B has a stepped shape smaller in outer diameter than the outer diameter of the containing tubular portion 36A. A cylindrical portion 51A of the cover member 51 is fitted to the outer peripheral side of the cover portion 36B. Further, a bottomed stepped hole 37 is formed in the housing 36 at a position inside the cover portion 36B. The stepped hole 37 includes a bush attachment hole portion 37A and a small-diameter hole portion 37B. The small-diameter hole portion 37B is located on a deeper side and formed to have a smaller diameter than this bush attachment hole portion 37A. A first bush 38 is provided in the bush attachment hole portion 37A. The first bush 38 serves as a bearing (a first bearing) for slidably supporting the actuation pin 49.

Further, the end surface of the cover portion 36B of the housing 36 on the opposite side thereof is disposed so as to face a cover portion 51B of the cover member 51 with an axial space generated therebetween. This axial space has a function of preventing an axial force from being directly applied from the cover portion 51B side of the cover member 51 to the housing 36 via the cover portion 36B. The cover portion 36B of the housing 36 does not necessarily have to be formed integrally with the containing tubular portion 36A using the same material (a magnetic body). The cover portion 36B in this case can also be made from, for example, a rigid metal material, a ceramic material, or a fiber-reinforced resin material, instead of the magnetic material. The containing tubular portion 36A and the cover portion 36B of the housing 36 are connected to each other at a position set in consideration of a transfer of a magnetic flux.

The yoke 39 is provided on one side in the movement direction of the armature 48. The yoke 39 is a magnetic member that establishes a magnetic circuit (a magnetic path) throughout the inner peripheral side and the outer peripheral side of the molded coil 34 (the coil 34A) together with the housing 36. In other words, the yoke 39 is formed using a magnetic material (a magnetic body) similarly to the housing 36. The yoke 39 includes the annular portion 39B and the tubular protrusion portion 39C. The annular portion 39B radially extends on the one axial side of the molded coil 34 (the coil 34A) (the one side in the direction of the winding axis) and includes a stepped fixation hole 39A on the inner peripheral side thereof. The tubular protrusion portion 39C protrudes tubularly along the axial direction of the fixation hole 39A from the inner peripheral side of the annular portion 39B toward the opposite axial side (toward the coil 34A side). The tubular protrusion portion 39C forms a protrusion (a tubular portion) for joining to the cylinder 44, and the cylinder 44 is inserted on the radially inner side of the tubular protrusion portion 39C.

More specifically, the yoke 39 includes the fixation hole 39A, and the anchor 41 is disposed in the fixation hole 39A. Further, an inward facing flange portion 39D is provided in the fixation hole 39A. The inward facing flange portion 39D protrudes radially inward along the entire circumference. The end surface of the cylinder 44 on the one axial side (one end surface) is in abutment with a side surface of the inward facing flange portion 39D (a side surface on the coil 34A side). Further, the outer periphery of the one axial side of the cylinder 44 is fitted to the inner periphery of the yoke 39, i.e., the inner surface of the fixation hole 39A (i.e., the inner peripheral surface of the tubular protrusion portion 39C).

Further, the yoke 39 is formed as an integrated member including the cylindrical one-side tubular portion 39G, an opposite-side tubular portion 39H, and a crimped portion 39J. The one-side tubular portion 39H extends from the outer peripheral side of the annular portion 39B toward the one axial side (the main valve 23 side). The opposite-side tubular portion 39H extends from the outer peripheral side of the annular portion 39B toward the opposite axial side (the cover member 51 side), and is formed so as to surround the molded coil 34 from the radially outer side. The crimped portion 39J holds a flange portion 51C of the cover member 51 provided on the distal end side of the opposite-side tubular portion 39H in a retained state. A cutout (not illustrated) is provided at the opposite-side tubular portion 39H of the yoke 39. This cutout is used to expose the cable extraction portion of the molded coil 34 to outside the opposite-side tubular portion 39H.

An engagement recessed portion 39L is provided between the one-side tubular portion 39G and the opposite-side tubular portion 39H of the yoke 39 (along the entire circumference or at a plurality of portions circumferentially spaced apart from each other). The engagement recessed portion 39L has a semi-circular shape in cross section so as to be opened on the outer peripheral surface of the yoke 39. The lock nut 55 is engaged with the engagement recessed portion 39L via a retaining ring 56 (refer to FIG. 2). The lock nut 55 is threadedly attached to the valve case 19. Further, a seal groove 39M is provided on the outer peripheral surface of the one-side tubular portion 39G along the entire circumference. An O-ring 40 (refer to FIG. 2) as a seal member is attached in the seal groove 39M. The O-ring 40 liquid-tightly seals between the yoke 39 (the one-side tubular portion 39G) and the valve case 19 of the damping force adjustment valve 18.

The anchor 41 is provided on the one side in the movement direction of the armature 48. The anchor 41 is disposed so as to axially face the armature 48. The anchor 41 is a stator (a fixed core) fixed in the fixation hole 39A of the yoke 39 using a method such as press-fitting. The anchor 41 is made from a magnetic material (a magnetic body) such as low-carbon steel or carbon steel for machine structural use (S10C) similarly to the housing 36 and the yoke 39, and is formed into a shape filling the fixation hole 39A of the yoke 39 from inside. The anchor 41 is formed as a short cylindrical annular member having an axially extending through-hole 41A on the central side thereof. The surface of the anchor 41 on the one axial side (the surface that axially faces the cap 31 illustrated in FIG. 2) is formed so as to be a flat surface similarly to the surface of the annular portion 39B of the yoke 39 on the one side.

A circular recessed dented portion 41B is provided in a recessed manner on an opposite axial side of the anchor 41 (the opposite-side surface that axially faces the armature 48) coaxially with the containing tubular portion 36A of the housing 36. The recessed dented portion 41B is formed as a circular groove slightly larger in diameter than the armature 48 so as to allow the armature 48 to be inserted inside it advanceably and retractably under a magnetic force. Accordingly, a cylindrical outer peripheral protrusion portion 41C is provided on the opposite side of the anchor 41. The outer peripheral surface of the outer peripheral protrusion portion 41C on the opening side thereof is formed as a conical surface so as to establish a linear (straight line) magnetic characteristic between the anchor 41 and the armature 48. In other words, the outer peripheral protrusion portion 41C, which is also called a corner portion, tubularly protrudes from the outer peripheral side of the anchor 41 to the opposite axial side. Then, the outer peripheral surface (the outer peripheral surface on the opening side) of the outer peripheral protrusion portion 41C is shaped like a conical surface inclined in a tapered manner so as to have an outer diameter dimension gradually reducing toward the opposite axial side (the opening side).

Further, a side surface portion 41D is formed on the outer peripheral side of the anchor 41. The side surface portion 41D extends in a direction away from the opening of the containing tubular portion 36A of the housing 36 along the outer periphery of the outer peripheral protrusion portion 41C. An annular flange portion 41E, which protrudes radially outward, is formed at an end portion of this side surface portion 41D on a far side away from the opening. The annular flange portion 41E is disposed at a position largely spaced apart from the opening end of the containing tubular portion 36A of the housing 36 to the one axial side (i.e., the end portion opposite from the recessed dented portion 41B).

The annular flange portion 41E is, for example, fixed in the fixation hole 39A of the yoke 39 using a method such as press-fitting. The annular flange portion 41E serves as a fixed portion of the anchor 41 (the side surface portion 41D) to the fixation hole 39A of the yoke 39, and also serves as a portion where the flange portion 41E and the fixation hole 39A radially face each other. The side surface portion 41D of the anchor 41 (except for the annular flange portion 41E) faces the inner peripheral surface of the cylinder 44 and the inner surface of the inward facing flange portion 39D of the yoke 39 via a space (a radial space).

As illustrated in FIG. 3, a second bush 43 is fittedly provided in the stepped through-hole 41A formed on the central (inner peripheral) side of the anchor 41. The second bush 43 serves as a bearing (a second bearing) for slidably supporting the actuation pin 49. On the other hand, as illustrated in FIG. 2, the pilot body 26, the return spring 28, the disk valve 29, the holding plate 30, the cap 31, and the like are placed by being inserted on the inner peripheral side of the one-side tubular portion 39G of the yoke 39. Further, the valve case 19 is fitted (externally fitted) on the outer peripheral side of the one-side tubular portion 39G.

The cylinder 44 is provided radially between the yoke 39 and the anchor 41. Further, the cylinder 44 is provided axially and radially between the yoke 39 and the housing 36. In other words, the cylinder 44 is a non-magnetic connection member (joint member) provided on the inner peripheral side of the molded coil 34 (the coil 34A) at a position between the small-diameter tubular portion 36C of the housing 36 and the tubular protrusion portion 39C of the yoke 39. The cylinder 44 is made of a non-magnetic body. More specifically, the cylinder 44 is formed as a cylindrical member (just a cylinder) from a non-magnetic material such as austenitic stainless steel.

The outer periphery of one end side (the yoke 39 side) of the cylinder 44 in the direction of the winding axis of the molded coil 34 (the coil 34A) is joined to the inner periphery of the yoke 39 (the fixation hole 39A and the tubular protrusion portion 39C). As a result, the one axial side of the cylinder 44 is fixed to the yoke 39 serving as a stator. Further, the inner periphery of an opposite end side (the housing 36 side) of the cylinder 44 in the direction of the winding axis of the molded coil 34 (the coil 34A) is joined to the outer periphery of the housing 36 (the small-diameter tubular portion 36C). In other words, the cylinder 44 is fitted (press-fitted) to the outer side (the outer peripheral side) of the small-diameter tubular portion 36C of the housing 36, and they are joined to each other by brazing.

The armature 48, which is also called a plunger, is disposed between the containing tubular portion 36A of the housing 36 and the recessed dented portion 41B of the anchor 41. The armature 48 is a mover (a moving core) made of a magnetic body provided movably in the direction of the winding axis of the coil 34A. In other words, the armature 48 is disposed on the inner peripheral side of the coil 34A axially movably. The armature 48 is arranged on the inner peripheral sides of the containing tubular portion 36A of the housing 36, the recessed dented portion 41B of the anchor 41, the tubular protrusion portion 39C of the yoke 39, and the cylinder 44, and is configured axially movably between the containing tubular portion 36A of the housing 36 and the recessed dented portion 41B of the anchor 41. In other words, the armature 48 is arranged on the inner peripheral sides of the containing tubular portion 36A of the housing 36 and the recessed dented portion 41B of the anchor 41, and is configured axially movably via the first and second bushes 38 and 43 and the actuation pin 49 under the magnetic force generated on the coil 34A.

The armature 48 is provided fixedly (integrally) to the actuation pin 49 extending through the central side thereof, and moves together with the actuation pin 49. The actuation pin 49 is axially slidably supported on the cover portion 36B of the housing 36 and the anchor 41 via the first and second bushes 38 and 43. Now, the armature 48 is generally cylindrically formed using a ferrous magnetic body similarly to, for example, the housing 36, the yoke 39, and the anchor 41. Then, a thrust force (an attraction force) is generated on the armature 48 in a direction for attracting the armature 48 toward inside the recessed dented portion 41B of the anchor 41 under the magnetic force generated on the coil 34A.

The actuation pin 49 is a shaft portion that transmits the thrust force of the armature 48 to the pilot valve member 32, and is made of a hollow rod. The actuation pin 49 is displaced integrally with the armature 48. More specifically, the armature 48 is integrally fixed to an axially intermediate portion of the actuation pin 49 using a method such as press-fitting, and the armature 48 and the actuation pin 49 are sub-assembled by that. The both axial sides of the actuation pin 49 are slidably supported on the cover portion 36B of the housing 36 side and the yoke 39 (the anchor 41) via the first and second bushes 38 and 43.

One end side (the end portion on the left side in FIG. 2 and the end portion on the lower side in FIG. 3) of the actuation pin 49 protrudes axially from the anchor 41 (the yoke 39), and, along therewith, the pilot valve member 32 of the damping force adjustment valve 18 is fixed to this protrusion end. Therefore, the pilot valve member 32 axially moves integrally together with the armature 48 and the actuation pin 49. In other words, the valve-opening setting pressure of the pilot valve member 32 is set to a pressure value corresponding to the thrust force of the armature 48 based on power supply to the coil 34A. The armature 48 opens and closes the pilot valve of the shock absorber 1 (i.e., opens and closes the pilot valve member 32 from and to the pilot body 26) by axially moving under the magnetic force from the coil 34A.

The cover member 51 is a magnetic cover that covers the molded coil 34 from outside together with the opposite-side tubular portion 39H of the yoke 39. This cover member 51 is made from a magnetic material (a magnetic body) as the cover member that covers the molded coil 34 from the opposite axial side, and establishes the magnetic circuit (the magnetic path) outside the molded coil 34 (the coil 34A) together with the opposite-side tubular portion 39H of the yoke 39. The cover member 51 is generally formed into a lidded cylindrical shape. More specifically, the cover member 51 includes the cylindrical portion 51A, a disk-like cover portion 51B, and the annular (ring-shaped) flange portion 51C. The cover portion 36B of the housing 36 is inserted through the cylindrical portion 51A. The cover portion 51B closes an opposite end side (the right end portion in FIG. 2 and the upper end portion in FIG. 3) of the cylindrical portion 51A. The flange portion 51C extends from the cover portion 51B to the radially outer side with respect to the cylindrical portion 51A.

In the embodiment, the cover member 51 includes a disk-like first member 52 and a second member 53 having a cylindrical portion 53A and an annular portion 53B to form the cover member 51 shaped in this manner. The first member 52 of the cover member 51 corresponds to the cover portion 51B and the flange portion 51C of the cover member 51. The cylindrical portion 53A of the second member 53 corresponds to the cylindrical portion 51A. The annular portion 53B of the second member 53 corresponds to the flange portion 51C.

The flange portion 51C of the cover member 51 is fixed to the crimped portion 39J provided on the opposite-side tubular portion 39H of the yoke 39. Due to that, the opposite-side tubular portion 39H of the yoke 39 and the cover portion 51B of the cover member 51 are preliminarily assembled (sub-assembled) with the molded coil 34 built inside them as illustrated in FIG. 3. In this manner, the cover portion 36B of the housing 36 is fittedly attached in the cylindrical portion 51A of the cover member 51 in the state that the molded coil 34 is built inside the opposite-side tubular portion 39H of the yoke 39 and the cover portion 51B of the cover member 51. Due to that, a magnetic flux can be transferred between the cylindrical portion 51A and the cover portion 51B of the cover member 51, and the yoke 39.

Further, a seal member (for example, an O-ring 54) is attached in a space surrounded by one end (the left end in FIG. 2 and the lower end in FIG. 3) of the cylindrical portion 51A of the cover member 51, the outer periphery of the cover portion 36B of the housing 36, and the inner periphery of the resin member 34C of the molded coil 34. The O-ring 54 liquid-tightly seals among the molded coil 34 (the resin member 34C), the cover member 51 (the cylindrical portion 51A), and the housing 36 (the cover portion 36B). Due to that, dust containing rainwater or mud water can be prevented from entering the inside via between the cover member 51 and the molded coil 34. The cover member 51 will be described in detail below.

The yoke 39 and the cover member 51 are fastened to the valve case 19 of the damping force adjustment valve 18 using the lock nut 55 and the retaining ring 56 serving as fastening members as illustrated in FIG. 2 with the molded coil 34 built inside them as illustrated in FIG. 3. In this case, the retaining ring 56 is attached to the engagement recessed portion 39L of the yoke 39 prior to the lock nut 55. This retaining ring 56 partially protrudes radially outward from the engagement recessed portion 39L of the yoke 39 and works to transmit the fastening force derived from the lock nut 55 to the one-side tubular portion 39G of the yoke 39.

The lock nut 55 is formed as a stepped tubular member, and includes an internally threaded portion 55A and an engagement tubular portion 55B. The internally threaded portion 55A is located on one axial side of the lock nut 55, and is threadedly engaged with the externally threaded portion 19B of the valve case 19 on the inner peripheral side thereof. The engagement tubular portion 55B is bent radially inward in such a manner that the inner diameter dimension thereof falls below the outer diameter dimension of the retaining ring 56, and is engaged with the retaining ring 56 from outside. The lock nut 55 is a fastening member for integrally coupling the damping force adjustment valve 18 and the solenoid 33 by threadedly engaging the internally threaded portion 55A and the externally threaded portion 19B of the valve case 19 with the inner surface of the engagement tubular portion 55B in abutment with the retaining ring 56 attached to the engagement recessed portion 39L of the yoke 39.

On the other hand, a cover member (a covering member) establishing a part of a magnetic circuit of a solenoid and serving as a cover of internal components of the solenoid including a coil is required to be designed to avoid magnetic saturation to achieve a reduction in the axial length and securement of a thrust force at the same time. As a result, the cover member has a complicated shape with a partial thickened portion. For example, the cover member has a shape including a disk-shaped portion and a cylindrically-shaped portion in combination. Then, forming the cover member by cutting to acquire such a shape leads to an increase in the cutting allowance extracted from the material, thereby reducing the yield and increasing the material cost. Further, the productivity is also impaired. Further, in a case where a pure iron-based soft magnetic material excellent in soft magnetic property is used as the cover member, the cutting workability is impaired because this material is soft metal.

In light thereof, in the embodiment, the cover member 51 is formed by pressing a plate-like member (a plate-like material) having an even thickness. Further, in the embodiment, the cover member 51 is formed using a plurality of differently shaped members (the first member 52 and the second member 53). Due to that, the embodiment is designed to secure the thrust force of the armature 48 serving as the mover, improve (increase) the yield of the cover member 51, improve the productivity, reduce the cost, and reduce control items from the material to the completion. The details of them will be described now.

First, as illustrated in FIG. 1, the shock absorber 1 includes the inner tube 4 and the outer tube 2 as the cylinder, the piston 5, the piston rod 8, the annular oil chamber D serving as the flow passage (more specifically, the flow passage between the annular oil chamber D and the reservoir chamber A), and the damping force adjustment valve 18 (the pilot valve member 32 and thus the main valve 23). The damping force adjustment valve 18 (the pilot valve member 32 and thus the main valve 23) is provided in the flow passage where the flow of the hydraulic fluid is generated due to the extraction/compression of the piston rod 8, i.e., provided between the annular oil chamber D and the reservoir chamber A. The damping force adjustment valve 18 (the pilot valve member 32 and thus the main valve 23) is driven by the solenoid 33.

Further, as illustrated in FIG. 2, the damping force adjustment mechanism 17 includes the coil 34A, the armature 48 as the mover, the anchor 41 as the stator, the housing 36 as the containing member, the cover member 51, and the damping force adjustment valve 18 (more specifically, the pilot valve member 32 and thus the main valve 23) as the control valve. The damping force adjustment valve 18 (the pilot valve member 32 and thus the main valve 23) is controlled according to the axial movement of the armature 48 fixed to the actuation pin 49. Further, as illustrated in FIG. 3, the solenoid 33 includes the coil 34A, the armature 48 as the mover, the anchor 41 as the stator, the housing 36 as the containing member, and the cover member 51.

The coil 34A is wound annularly, and generates a magnetic force in reaction to power supply. The armature 48 is made of a magnetic body. The armature 48 is provided movably in the direction of the winding axis of the coil 34A. The anchor 41 is provided on the one side in the movement direction of the armature 48 (the lower side in the vertical direction in FIG. 3). The armature 48 is contained in the housing 36. The housing 36 is provided radially between the coil 34A and the armature 48. The housing 36 is opened on the one end side thereof in the axial direction of the coil 34A (the lower side in the vertical direction in FIG. 3). The cover member 51 covers the coil 34A therewith. The cover member 51 establishes the magnetic circuit.

Then, as illustrated in FIG. 3, the cover member 51 is formed by pressing a plate-like member having an even thickness. In other words, the cover member 51 is constituted by, for example, the first member 52 and the second member 53 formed by pressing a plate-like metallic material having an even thickness. Accordingly, the cover member 51 is constituted by the first member 52 and the second member 53, which are the plurality of differently shaped members. In other words, the cover member 51 includes the disk-like first member 52 and the second member 53 having an L-like shape in cross section. These first member 52 and second member 53 are individual separate components. The pressing is, for example, a processing method of applying a pressure to a material such as a metal or non-metal material using a pair of two or more tools (for example, dies, an upper die and a lower die, or a core and a cavity), thereby cutting or shaping it into a predetermined shape or dimension. The pressing includes, for example, shearing, drawing, bending, forging, stretch forming, rotary forming, and hydroforming.

The first member 52 and the second member 53 may be prepared as a component integrated inseparably by, for example, being glued to each other, or may be prepared as still separable different components without being glued to each other. The second member 53 includes the cylindrically-shaped cylindrical portion 53A and the flange-shaped annular portion 53B. The flange portion 53B extends from the opening edge of the cylindrical portion 53A on one end side (the first member 52 side) radially outward along the entire circumference. The cylindrical portion 53A of the second member 53 is fitted to the cover portion 36B of the housing 36. In other words, the cover member 51 includes the cylindrical portion 51A (the cylindrical portion 53A) provided between the coil 34A and the housing 36. On the other hand, the outer diameter of the housing 36 includes the cover portion 36B, which corresponds to a small-diameter portion, and the containing tubular portion 36A, which corresponds to a large-diameter portion. Then, the cylindrical portion 51A of the cover member 51, i.e., the cylindrical portion 53A of the second member 53 is press-fitted to the cover portion 36B.

In this case, the cover portion 36B and the containing tubular portion 36A of the housing 36 are connected to each other via a stepped portion 36D therebetween. Then, the O-ring 54 serving as the seal member is provided between the stepped portion 36D of the housing 36 and the cylindrical portion 51A of the cover member 51. Further, in the embodiment, the cylindrical portion 53A, which corresponds to the cylindrical portion 51A of the cover member 51, and the annular portion 53B, which corresponds to a portion other than this cylindrical portion 51A, are integrally formed on the second member 53 of the cover member 51. On the other hand, the cylindrical portion 53A of the second member 53 (the cylindrical portion 51A) is formed separately from the first member 52, which corresponds to the portion other than the cylindrical portion 51A. In other words, the cylindrical portion 51A of the cover member 51 (the cylindrical portion 53A of the second member 53) is formed integrally with the annular portion 53B of the second member 53, and is formed separately from the first member 52.

Further, the outer peripheral side of the coil 34A is covered with the opposite-side tubular portion 39H of the yoke 39, which corresponds to the case member. In other words, the solenoid 33 includes the yoke 39, more specifically, the opposite-side tubular portion 39H covering the outer periphery of the coil 34A. A large-diameter portion 39H1 and a small-diameter portion 39H2 connected to this large-diameter portion 39H1 are formed on the one end of the inner periphery of the opposite-side tubular portion 39H. The cover member 51 is placed on a stepped portion 39H3 defined by the large-diameter portion 39H1 and the small-diameter portion 39H2. Along therewith, the cover member 51 is fixed to the opposite-side tubular portion 39H by crimping the large-diameter portion 39H1 to the cover member 51 (the flange portion 51C). Further, in the embodiment, the cover member 51 covers the opposite axial end side (the cover portion 36B) of the housing 36.

In this case, a space is generated between the first member 52 of the cover member 51 and the opposite axial end surface (the end surface of the cover portion 36B) of the housing 36. On the other hand, the annular portion 53B of the second member 53 is in contact with the first member 52. In other words, the first member 52 and the annular portion 53B of the second member 53 are in contact with each other with the large-diameter portion 39H1 of the opposite-side tubular portion 39H crimped to the cover member 51 (the flange portion 51C). Further, the annular portion 53B of the second member 53 is in contact with the stepped portion 39H3 of the opposite-side tubular portion 39H with the large-diameter portion 39H1 of the opposite-side tubular portion 39H crimped to the cover member 51 (the flange portion 51C). By this configuration, the cover member 51 establishes the magnetic circuit.

In the embodiment, the cover member 51 is constituted by the plate-like member having an even thickness (the first member 52 and the second member 53) to increase the productivity of the cover member 51, which establishes the magnetic circuit. In other words, the cover member 51 is constituted by the first member 52 and the second member 53, which are a plurality of members (a plurality of components). Further, the cover member 51, more specifically, the first member 52 and the second member 53 used as the members (components) constituting the cover member 51 are shaped so as to be able to be formed by pressing. This can contribute to a reduction in the cost of the cover member 51 and the improvement of the productivity.

The solenoid 33, the damping force adjustment mechanism 17, and the shock absorber 1 according to the present embodiment are configured in the above-described manner, and the operations thereof will be described next.

First, when the shock absorber 1 is mounted on a vehicle such as an automobile, for example, the upper end side (the protruding end side) of the piston rod 8 is attached to the vehicle body side of the vehicle, and the mounting eye 3A side provided on the bottom cap 3 is attached to the wheel side. Further, the solenoid 33 of the damping force adjustment mechanism 17 is connected to a control apparatus (a controller) provided on the vehicle body side of the vehicle via, for example, the electric wiring cable (both are not illustrated).

When the vehicle runs, upon occurrence of a vertical vibration due to unevenness of a road surface or the like, the piston rod 8 is displaced so as to extend or compress from and into the outer tube 2, and therefore the damping force can be generated by the damping force adjustment mechanism 17 and the like and the vibration of the vehicle can be damped. At this time, the generated damping force of the shock absorber 1 can be variably adjusted by controlling a current value directed to the coil 34A of the solenoid 33 using the controller to thus adjust the valve-opening pressure of the pilot valve member 32.

For example, during the extension stroke of the piston rod 8, the compression-side check valve 7 of the piston 5 is closed due to the movement of the piston 5 in the inner tube 4. Before the disk valve 6 of the piston 5 is opened, the oil fluid in the rod-side oil chamber B is pressurized, thereby being delivered into the oil passage 20B of the connection tubular member 20 of the damping force adjustment valve 18 via the oil hole 4A of the inner tube 4, the annular oil chamber D, and the connection port 12C of the intermediate tube 12. At this time, the oil fluid flows from the reservoir chamber A into the bottom-side oil chamber C by opening the extension-side check valve 16 of the bottom valve 13 by an amount corresponding to the movement of the piston 5. When the pressure in the rod-side oil chamber B reaches the valve-opening pressure of the disk valve 6, this disk valve 6 is opened and relieves the pressure in the rod-side oil chamber B by releasing it into the bottom-side chamber C.

In the damping force adjustment mechanism 17, before the main valve 23 is opened (in a low piston speed region), the oil fluid delivered into the oil passage 20B of the connection tubular member 20 is transmitted into the pilot body 26 by passing through the central hole 21A of the valve member 21, the central hole 24B of the pilot pin 24, and the central hole 26C of the pilot body 26, and pushing and opening the pilot valve member 32, as indicated by the arrow X in FIG. 2. Then, the oil fluid transmitted into the pilot body 26 flows into the reservoir chamber A by passing through between the flange portion 32A of the pilot valve member 32 and the disk valve 29, the oil passage 30A of the holding plate 30, the cutouts 31A of the cap 31, and the oil chamber 19C of the valve case 19. When the pressure in the oil passage 20B of the connection tubular member 20, i.e., the pressure in the rod-side oil chamber B reaches the valve-opening pressure of the main valve 23 according to an increase in the piston speed, the oil fluid delivered into the oil passage 20B of the connection tubular member 20 flows into the reservoir chamber A by passing through the oil passages 21B of the valve member 21, pushing and opening the main valve 23, and passing through the oil chamber 19C of the valve case 19, as indicated by the arrow Y in FIG. 2.

On the other hand, during the compression stroke of the piston rod 8, the compression-side check valve 7 of the piston 5 is opened and the extension-side check valve 16 of the bottom valve 13 is closed due to the movement of the piston 5 in the inner tube 4. Before the bottom valve 13 (the disk valve 15) is opened, the oil fluid in the bottom-side oil chamber C flows into the rod-side oil chamber B. Along therewith, the oil fluid flows from the rod-side oil chamber B into the reservoir chamber A via the damping force adjustment valve 18 by passing through a similar route to the route during the extension stroke by an amount corresponding to the entry of the piston rod 8 into the inner tube 4. When the pressure in the bottom-side chamber C reaches the valve-opening pressure of the bottom valve 13 (the disk valve 15), the bottom valve 13 (the disk valve 15) is opened and relieves the pressure in the bottom-side oil chamber C by releasing it into the reservoir chamber A.

As a result, during the extension stroke and the compression stroke of the piston rod 8, the damping force is generated due to the orifice 24C of the pilot pin 24 and the valve-opening pressure of the pilot valve member 32 before the main valve 23 of the damping force adjustment valve 18 is opened, and is generated according to the valve lift of the main valve 23 after this main valve 23 is opened. In this case, the damping force can be directly controlled regardless of the piston speed by adjusting the valve-opening pressure of the pilot valve member 32 using the power supply to the coil 34A of the solenoid 33.

More specifically, supplying a lower current to the coil 34A to reduce the thrust force on the armature 48 leads to a reduction in the valve-opening pressure of the pilot valve member 32, thereby resulting in generation of a soft-side damping force. On the other hand, supplying a higher current to the coil 34A to increase the thrust force on the armature 48 leads to an increase in the valve-opening pressure of the pilot valve member 32, thereby resulting in generation of a hard-side damping force. At this time, the valve-opening pressure of the pilot valve member 32 causes a change in the inner pressure in the back-pressure chamber 27 in communication via the oil passages 25 on the upstream side thereof. According thereto, controlling the valve-opening pressure of the pilot valve member 32 can be accompanied by adjusting the valve-opening pressure of the main valve 23 at the same time, thereby resulting in an increase in the adjustable range of the damping force characteristic.

In a case where the thrust force on the armature 48 is lost due to, for example, a disconnection of the coil 34A, the pilot valve member 32 is retracted (displaced in the direction away from the valve seat portion 26E) by the return spring 28, and the flange portion 32A of the pilot valve member 32 and the disk valve 29 abut against each other. In this state, a damping force can be generated due to the valve-opening pressure of the disk valve 29, and a required damping force can be acquired even at the time of a malfunction such as the disconnection of the coil.

Then, according to the embodiment, the first member 52 and the second member 53, which constitute the cover member 51, are formed by pressing a plate-like member (a plate-like material) having an even thickness. Further, the cover member 51 is constituted by the first member 52 and the second member 53, which are the plurality of differently shaped members. Therefore, the productivity can be improved while the flexibility of the shape of the cover member 51 is ensured. In other words, the embodiment can improve (increase) the yield of the cover member 51, improve the productivity, reduce the cost, and reduce the control items from the material to the completion while securing the thrust force of the armature 48 compared to a cover member formed by cutting. Further, the cover member 51 can be easily formed even when the pure iron-based soft magnetic material excellent in soft magnetic property is used as the cover member 51. Therefore, the productivity can be ensured even when the shape of the cover member 51 is complicated to secure the thrust force of the armature 48. To put it the other way around, the area of a magnetically necessary portion can be secured and a reduction in the thrust force (magnetic saturation) can be prevented while the productivity is ensured. As a result, the embodiment can ensure the performance and improve the productivity of the solenoid 33 and the damping force adjustment mechanism 17, and thus the shock absorber 1 at the same time.

According to the embodiment, the cover member 51 includes the cylindrical portion 51A (i.e., the cylindrical portion 53A of the second member 53) provided between the coil 34A and the housing 36. Therefore, the magnetic circuit can be established by the cylindrical portion 51A (the cylindrical portion 53A). Due to that, the productivity can be improved while the magnetic circuit is optimized.

According to the embodiment, the housing 36 includes the cover portion 36B, which corresponds to the small-diameter portion, the containing tubular portion 36A, which corresponds to the large-diameter portion, and the stepped portion 36D between the cover portion 36B and the containing tubular portion 36A. Along therewith, the cylindrical portion 51A of the cover member 51 (the cylindrical portion 53A) is press-fitted to the cover portion 36B. Due to that, the housing 36 can be prevented from rattling from the cover member 51. Further, the O-ring 54, which corresponds to the seal member, is provided between the stepped portion 36D of the housing 36 and the cylindrical portion 51A of the cover member 51 (the cylindrical portion 53A). Due to that, the space between the housing 36 and the cover member 51 can be closed by the O-ring 54. As a result, entry of moisture (water) such as rainwater or mud water from outside can be prevented.

According to the embodiment, the cylindrical portion 53A of the second member 53 of the cover member 51 is formed integrally with the annular portion 53B of the second member 53, and is formed separately from the first member 52. Due to that, the cover member 51 can be constituted by two components with the cylindrical portion 51A formed separately.

According to the embodiment, the cover member 51 is placed on the stepped portion 39H3 of the opposite-side tubular portion 39H of the yoke 39, and is fixed to the yoke 39 (the opposite-side tubular portion 39H) by crimping the large-diameter portion 39H1 of the opposite-side tubular portion 39H to the cover member 51. Therefore, the cover member 51 can be fixed to the yoke 39 (the opposite-side tubular portion 39H) with an axial space secured between the cover member 51 and the housing 36. Therefore, even when a load is imposed on the cover member 51, this load can be prevented from being applied to the housing 36. As a result, an excessive force can be prevented from being applied to the housing 36, and thus the durability and the impact resistance can be improved.

According to the embodiment, the cover member 51 covers the opposite axial end side (the end portion of the cover portion 36B) of the housing 36. Due to that, the housing 36 (the cover portion 36B) can be protected with the aid of the cover member 51.

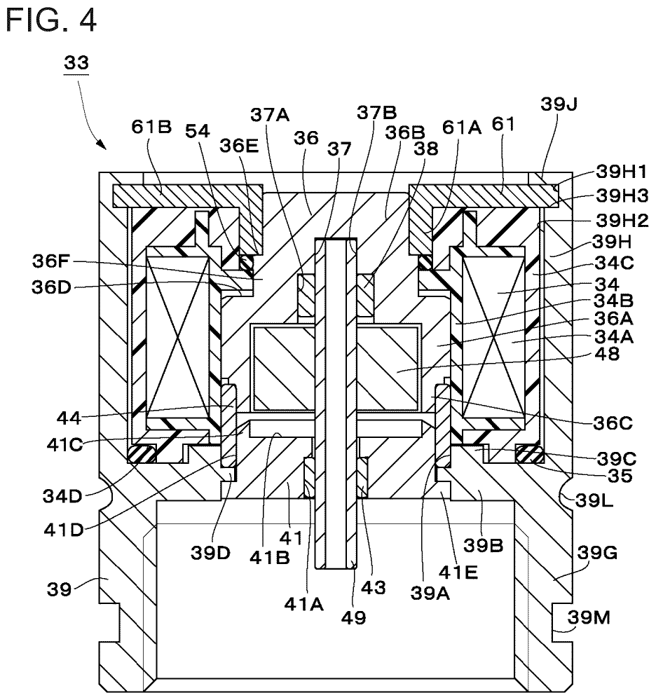

The embodiment has been described citing the example in which the cover member 51 is constituted by two members (the plurality of members), namely, the first member 52 and the second member 53. However, without being limited thereto, the cover member may be constituted by a single member (one member). More specifically, the cover member may be configured in such a manner that, for example, like a first modification illustrated in FIG. 4, a cover member 61 is constituted by a single member having an L-like shape in vertical cross section similarly to the second member 53 according to the embodiment (FIG. 3). In this case, the cover member 61 according to the first modification has a greater thickness than the second member 53 according to the embodiment (FIG. 3).

The cover member 61 according to the first modification includes a cylindrically-shaped cylindrical portion 61A and a flange-like annular portion 61B. The annular portion 61B extends from the opening edge of this cylindrical portion 61A on one end side (the opposite side from the armature 48) radially outward along the entire circumference. The cylindrical portion 61A corresponds to the cylindrical portion provided between the coil 34A and the housing 36. The cylindrical portion 61A is press-fitted to the cover portion 36B of the housing 36. The annular portion 61B corresponds to the annular (ring-shaped) flange portion extending from the cylindrical portion 61A radially outward. The cover member 61 is formed by pressing a plate-like member (for example, a plate-like metallic material) having an even thickness. In this case, the cylindrical portion 61A, and the annular portion 61B, which corresponds to the portion other than this cylindrical portion 61A, are integrally formed on the cover member 61.

Further, the O-ring 54, which corresponds to the seal member, is provided between the stepped portion 36D of the housing 36 and the cylindrical portion 61A of the cover member 61. In this case, another stepped portion 36E is formed on the cover portion 36B of the housing 36 at a position closer to the cover member 61 side than the stepped portion 36D is. Therefore, the housing 36 includes an intermediate tubular portion 36F, which has an outer diameter dimension larger than the cover portion 36B and smaller than the containing tubular portion 36A, between the containing tubular portion 36A and the cover portion 36B.

The cylindrical portion 61A of the cover member 61 extends toward the other stepped portion 36E of the housing 36. Then, the O-ring 54 is disposed among the outer peripheral surface of the intermediate tubular portion 36F, the cylindrical portion 61A of the cover member 61, and the inner peripheral surface of the molded coil 34 (the resin member 34C). In other words, the O-ring 54 is provided between the stepped portion 36D and the cylindrical portion 61A of the cover member 61. Further, the cover member 61 is fixed to the opposite-side tubular portion 39H by crimping the large-diameter portion 39H1 of the yoke 39 to the cover member 61. Further, in the first modification, the opposite axial end side (the cover portion 36B) of the housing 36 is inserted through the cover member 61 (the cylindrical portion 61A and the annular portion 61B). A space is generated between one end side of the cylindrical portion 61A of the cover member 61 and the other stepped portion 36E of the housing 36 with the large-diameter portion 39H1 of the opposite-side tubular portion 39H crimped to the cover member 61.

The first modification configured in this manner can also improve (increase) the yield of the cover member 61, improve the productivity, reduce the cost, and reduce the control items from the material to the completion while securing the thrust force of the armature 48, similarly to the embodiment. Especially, in the first modification, the cylindrical portion 61A (the cylindrical portion) and the annular portion 61B (the portion other than the cylindrical portion) of the cover member 61 are integrally formed. This allows the cover member 61 to be constituted by one component with the cylindrical portion 61A formed integrally. Further, in the first modification, the opposite axial end side (the cover portion 36B) of the housing 36 is inserted through the cover member 61. This allows the housing 36 (the cover portion 36B) to be exposed from the cover member 61.

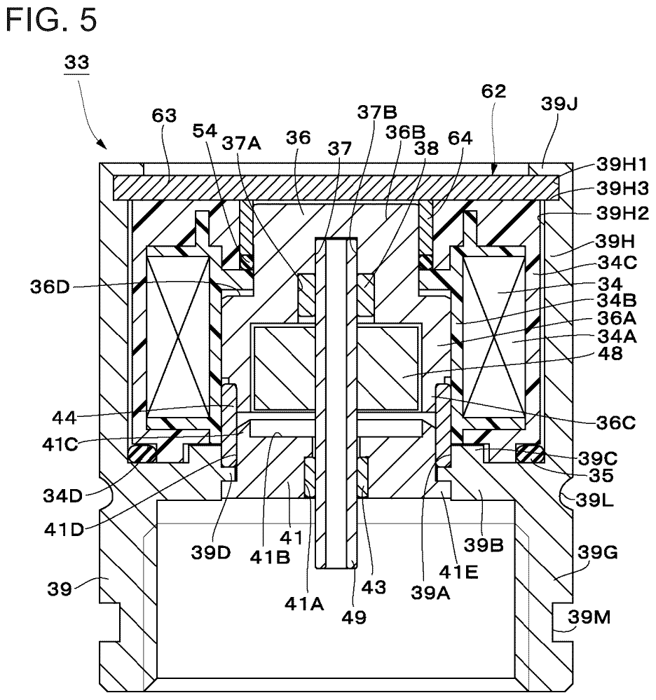

The above-described embodiment has been described citing the example in which the cover member 51 is constituted by the “disk-like first member 52” and the “second member 53 having an L-like shape in cross section”. However, without being limited thereto, the cover member may be constituted by a “disk-like first member” and a “cylindrical second member”. More specifically, the cover member may be configured in such a manner that, for example, like a second modification illustrated in FIG. 5, a cover member 62 is constituted by a disk-like first member 63 and a cylindrical second member 64. In this case, the first member 63 according to the second modification has a greater thickness than the first member 52 according to the embodiment (FIG. 3). The first member 63 and second member 64 are also individual separate components in the second modification, similarly to the embodiment. The first member 63 and the second member 64 may be prepared as a component integrated inseparably by, for example, being glued to each other, or may be prepared as still separable different components without being glued to each other.

At least the first member 63 in the cover member 62 is formed by pressing a plate-like member (for example, a plate-like metallic material) having an even thickness. The second member 64 is a pipe (a circular tube), and is provided between the coil 34A and the housing 36. The second member 64 corresponds to the cylindrical portion of the cover member 62. The second member 64 is press-fitted to the cover portion 36B of the housing 36. The second member 64 configured in this manner may be formed by either pressing or other processing different from pressing. In either case, the cover member 62 is constituted by the first member 63 and the second member 64, which are the plurality of differently shaped members. Then, the second member 64, which corresponds to the cylindrical portion, and the first member 63, which corresponds to the portion other than that, are formed as separate components in the cover member 62.

Further, the O-ring 54, which corresponds to the seal member, is provided between the stepped portion 36D of the housing 36 and the second member 64 of the cover member 61. Further, the cover member 62 is fixed to the opposite-side tubular portion 39H by crimping the large-diameter portion 39H1 of the yoke 39 to the first member 63 of the cover member 51. Further, in the second modification, the first member 63 of the cover member 62 covers the opposite axial end side (the cover portion 36B) of the housing 36. In this state, a space is generated between the first member 63 of the cover member 62 and the opposite axial end surface (the end surface of the cover portion 36B) of the housing 36. On the other hand, the second member 64 is in contact with the first member 63, and the radially outer side of the first member 63 is in contact with the stepped portion 39H3 of the opposite-side tubular portion 39H.

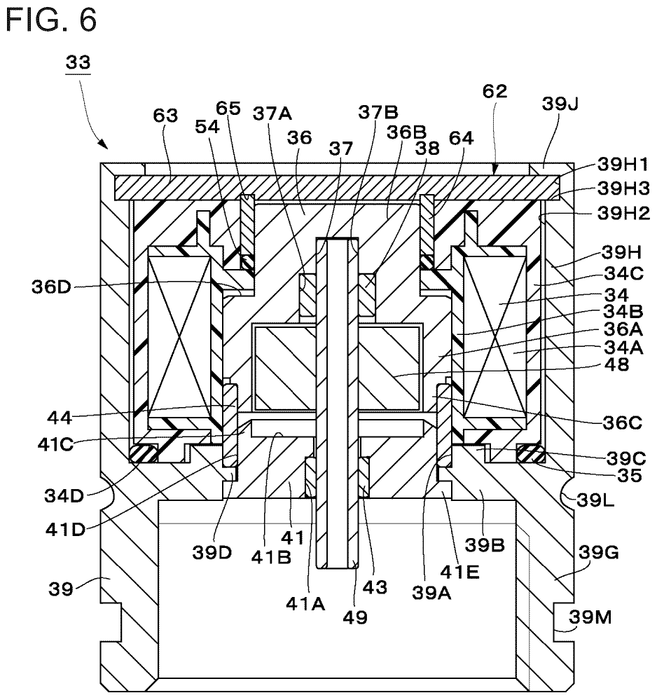

The second modification configured in this manner can also improve (increase) the yield of the cover member 61, improve the productivity, reduce the cost, and reduce the control items from the material to the completion while securing the thrust force of the armature 48, similarly to the embodiment. Especially, in the second modification, the cylindrical portion of the cover member 62 that is press-fitted to the cover portion 36B of the housing 36 is constituted by the cylindrical second member 64. Therefore, the cover member 62 can be constituted by two components using the second member 64 corresponding to the cylindrical portion and the disk-like first member 63. Like a third modification illustrated in FIG. 6, a positioning recessed portion 65 for positioning the second member 64 may be provided at a position of the first member 63 that faces the second member 64. The positioning recessed portion 65 is formed as an annular recessed groove to which the end portion (the end edge) of the second member 64 is fitted. According to the third modification configured in this manner, the end portion (the end edge) of the second member 64 and the first member 63 can be stably kept in contact with each other.

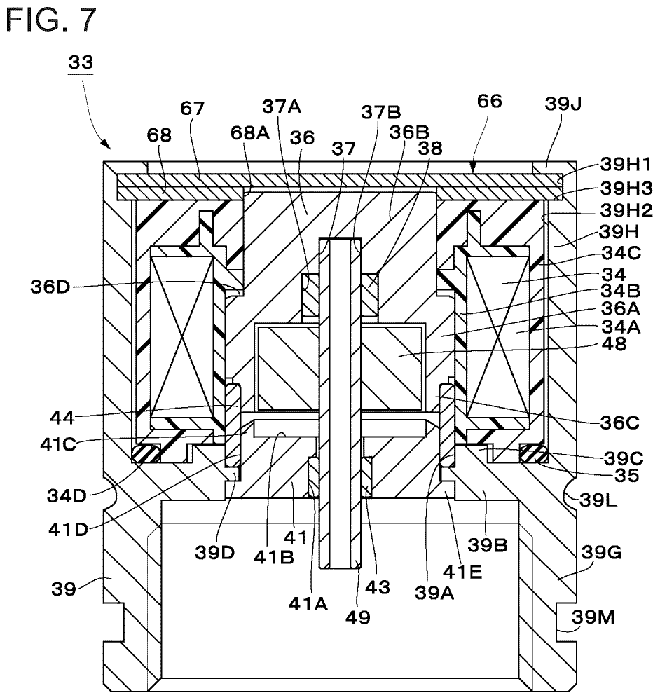

The above-described embodiment has been described citing the example in which the cover member 51 is constituted by the “disk-like first member 52” and the “second member 53 having an L-like shape in cross section”. However, without being limited thereto, the cover member may be constituted by a “disk-like first member” and an “annular (ring-shaped) second member”. More specifically, the cover member may be configured in such a manner that, for example, like a fourth modification illustrated in FIG. 7, a cover member 66 is constituted by a disk-like first member 67 and an annular (ring-shaped) second member 68. A circular through-hole 68A is provided to the second member 68. The opposite axial end side (the cover portion 36B) of the housing 36 is fitted in the through-hole 68A.

In the fourth modification, the first member 67 and the second member 68 of the cover member 66 are formed by pressing a plate-like member (for example, a plate-like metallic material) having an even thickness. The cover member 66 is constituted by the first member 67 and the second member 68, which are the plurality of differently shaped members. The first member 67 corresponds to a first plate-like member having an even thickness. The second member 68 corresponds to a second plate-like member. The second plate-like member is located closer to the coil 34A side than the first member 67 is, and is disposed so as to overlap the first member 67. The second plate-like member is smaller in area than the first member 67. The cover member 66 is fixed to the opposite-side tubular portion 39H by crimping the large-diameter portion 39H1 of the yoke 39 to the first member 67 of the cover member 66. The first member 67 of the cover member 66 covers the opposite axial end side (the cover portion 36B) of the housing 36. In this state, a space is generated between the first member 67 of the cover member 66 and the opposite axial end surface (the end surface of the cover portion 36B) of the housing 36. On the other hand, the first member 67 and the second member 68 are in contact with each other, and the radially outer side of the second member 68 is in contact with the stepped portion 39H3 of the opposite-side tubular portion 39H.

The fourth modification configured in this manner can also improve the productivity while securing the thrust force of the armature 48 similarly to the embodiment, the first modification, the second modification, and the third modification. Especially, in the fourth modification, the cover member 66 includes the first plate-like member (the first member 67) having an even thickness, and the second plate-like member (the second member 68) located closer to the coil 34A side than this first plate-like member (the first member 67) is and smaller in area than the first plate-like member (the first member 67). Due to that, the second plate-like member (the second member 68) can be arranged at a portion where magnetic saturation occurs. Therefore, the cover member 66 can be easily formed while the thrust force of the armature 48 is secured with the aid of the first plate-like member (the first member 67) and the second plate-like member (the second member 68).

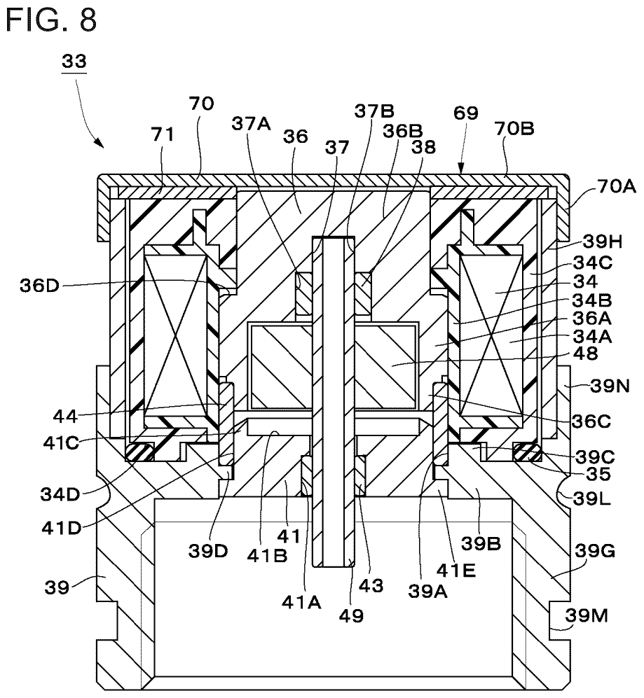

The above-described embodiment has been described citing the example in which the cover member 51 is fixed to the yoke 39 (the opposite-side tubular portion 39H) by crimping the cover member 51 to the yoke 39 (the opposite-side tubular portion 39H) corresponding to the case member. However, without being limited thereto, the cover member may be fixed to the case member (the yoke or the opposite-side tubular portion) by press-fitting. More specifically, the cover member may be configured in such a manner that, for example, like a fifth modification illustrated in FIG. 8, a cover member 69 is constituted by a first member 70 and a second member 71 and is fixed to the yoke 39 (the opposite-side tubular portion 39H) corresponding to the case member by press-fitting the first member 70 (an outer cylindrical portion 70A) to the yoke 39 (the opposite-side tubular portion 39H).

Then, in the embodiment (FIG. 3), the opposite-side tubular portion 39H of the yoke 39 is formed integrally with the annular portion 39B and the one-side tubular portion 39G of the yoke 39. On the other hand, in the fifth modification (FIG. 6), the opposite-side tubular portion 39H of the yoke 39 is formed separately from the annular portion 39B and the one-side tubular portion 39G. In other words, the opposite-side tubular portion 39H is fixed to the inside (the inner peripheral surface side) of a cylindrical fixation tubular portion 39N extending from the annular portion 39B toward the cover member 69 side by press-fitting, gluing, or the like. Along therewith, the cover member 69 is fixed to the outside (the outer peripheral surface side) of the opposite-side tubular portion 39H by press-fitting.

The cover member 69 includes the lidded tubular first member 70 and the annular (ring-shaped) second member 71. The first member 70 and second member 71 are individual separate components. The first member 70 and the second member 71 may be prepared as a component integrated inseparably by being glued to each other, or may be prepared as still separable different components without being glued to each other. The first member 70 includes the cylindrically-shaped outer cylindrical portion 70A and a disk-like cover portion 70B. The outer cylindrical portion 70A is fixed to the opposite-side tubular portion 39H of the yoke 39 by press-fitting. The cover portion 70B covers the opening of the outer cylindrical portion 70A on one end side thereof. The second member 71 is disposed inside the outer cylindrical portion 70A of the first member 70, and is in abutment (contact) with the cover portion 70B of the first member 70. A space is generated between the cover portion 70B of the first member 70 and the opposite axial end surface (the end surface of the cover portion 36B) of the housing 36. Further, the distal end side (the opposite end side) of the opposite-side tubular portion 39H is in abutment (contact) with the radially outer side of the second member 71.

In the fifth modification, the first member 70 and the second member 71 of the cover member 69 are also formed by pressing a plate-like member (for example, a plate-like metallic material) having an even thickness. The cover member 69 is constituted by the first member 70 and the second member 71, which are the plurality of differently shaped members. The first member 70 corresponds to the first plate-like member having an even thickness. The second member 71 corresponds to the second plate-like member. The second plate-like member is located closer to the coil 34A side than the first member 70 is, and is disposed so as to overlap the first member 70. The second plate-like member is smaller in area than the first member 70. The first member 70 of the cover member 69 covers the opposite axial end side (the cover portion 36B) of the housing 36. The fifth modification configured in this manner can also improve the productivity while securing the thrust force of the armature 48.

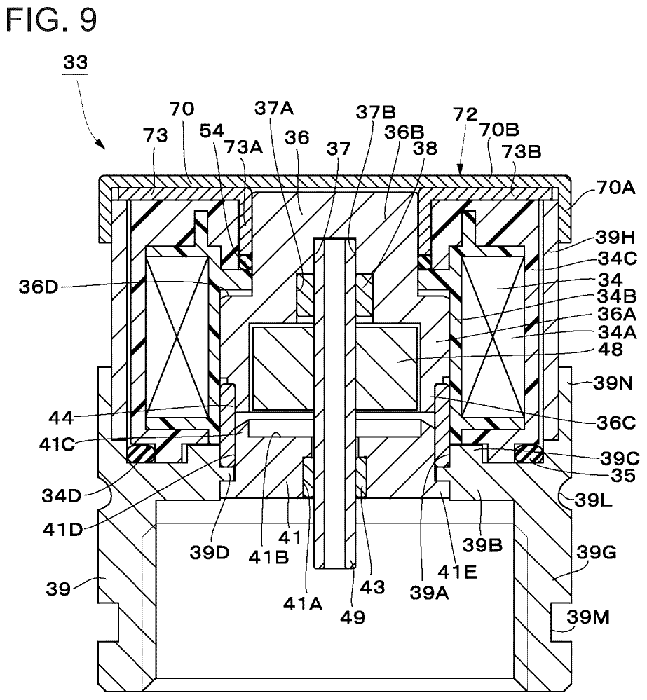

The fifth modification has been described citing the example in which the second member 71 of the cover member 69 is formed annularly (into a ring-like shape). However, without being limited thereto, the cover member may be configured in such a manner that, for example, like a sixth modification illustrated in FIG. 9, a cover member 72 is constituted by the first member 70 and a second member 73, and the second member 73 includes a cylindrical portion 73A and an annular portion 73B similarly to the second member 53 according to the embodiment (FIG. 3). The cylindrical portion 73A of the second member 73 corresponds to the cylindrical portion provided between the coil 34A and the housing 36. The cylindrical portion 73A of the second member 73 is press-fitted to the cover portion 36B.

In the sixth modification, the first member 70 and the second member 73 of the cover member 72 are also formed by pressing a plate-like member (for example, a plate-like metallic material) having an even thickness. The cover member 72 is constituted by the first member 70 and the second member 73, which are the plurality of differently shaped members. The first member 70 corresponds to the first plate-like member having an even thickness. The second member 73 corresponds to the second plate-like member. The second plate-like member is located closer to the coil 34A side than the first member 70 is, and is disposed so as to overlap the first member 70. The second plate-like member is smaller in area than the first member 70. The first member 70 of the cover member 72 covers the opposite axial end side (the cover portion 36B) of the housing 36. The cylindrical portion 73A of the second member 73 is formed integrally with the annular portion 73B of the second member 73, and is formed separately from the first member 70. The annular portion 73B of the second member 73 is disposed inside the outer cylindrical portion 70A of the first member 70, and is in abutment with the cover portion 70B of the first member 70. A space is generated between the cover portion 70B of the first member 70 and the opposite axial end surface (the end surface of the cover portion 36B) of the housing 36. Further, the distal end side (the opposite end side) of the opposite-side tubular portion 39H is in abutment (contact) with the radially outer side of the second member 73. The sixth modification configured in this manner can also improve the productivity while securing the thrust force of the armature 48.

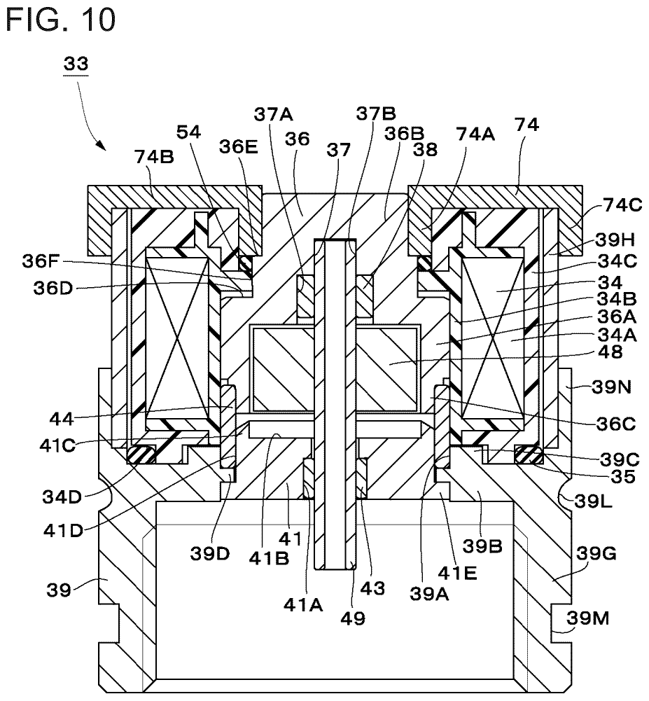

The fifth modification and the sixth modification have been described citing the example in which the cover member 69 or 72 is constituted by the first member 70 and the second member 71 or 73. However, without being limited thereto, the cover member may be configured in such a manner that, for example, like a seventh modification illustrated in FIG. 10, a cover member 74 is constituted by a single member. The cover member 74 according to the seventh modification includes a cylindrically-shaped cylindrical portion 74A, and a flange-like annular portion 74B extending from the opening edge of this cylindrical portion 74A on one end side thereof (the opposite side from the armature 48) radially outward along the entire circumference, similarly to the cover member 61 according to the first modification (FIG. 4). In addition thereto, the cover member 74 according to the seventh modification includes an outer cylindrical portion 74C on the outer peripheral edge side of the annular portion 74B. The outer cylindrical portion 74C is fixed to the opposite-side tubular portion 39H of the yoke 39 by press-fitting. The annular portion 74B of the cover member 74 is in abutment (contact) with the distal end side (the opposite end side) of the opposite-side tubular portion 39H with the cover member 74 (the outer cylindrical portion 74C) fixed to the opposite-side tubular portion 39H of the yoke 39 by press-fitting. On the other hand, a space is generated between one end side (the armature 48 side) of the cylindrical portion 74A of the cover member 74 and the other stepped portion 36E of the housing 36. The seventh modification configured in this manner can also improve the productivity while securing the thrust force of the armature 48.

The embodiment and the modifications have been described citing the example in which the housing 36 and the cylinder 44, and the cylinder 44 and the yoke 39 are joined to each other via the brazing material. However, without being limited thereto, for example, the housing 36 and the cylinder 44, and the cylinder 44 and the yoke 39 may be joined with each other by welding.

The embodiment and the modifications have been described citing the example in which the anchor 41 is fixed in the fixation hole 39A of the yoke 39 by press-fitting. However, without being limited thereto, the anchor may be configured to be fixed in the yoke using, for example, a threaded engagement method such as a screw, or a crimping method.

The embodiment and the modifications have been described citing the example in which the anchor 41 and the yoke 39 are configured as separate members (separate components). However, without being limited thereto, for example, the anchor and the yoke may be configured integrally (as one member).

The embodiment and the modifications have been described citing the example in which the cylinder 44 is configured in such a manner that the one side thereof is fixed to the yoke 39. However, without being limited thereto, the cylinder (the joint member) may be configured in such a manner that, for example, the one side thereof is fixed to the anchor.

The embodiment and the modifications have been described citing the example in which the solenoid 33 is configured as a proportional solenoid. However, without being limited thereto, the solenoid may be configured as, for example, an ON/OFF-type solenoid.

The embodiment and the modifications have been described citing the twin tube-type shock absorber 1 including the outer cylinder 2 and the inner cylinder 4 by way of example. However, without being limited thereto, the present invention may be used for, for example, a damping force adjustable shock absorber constructed using a single tube-type tubular member (cylinder).

The embodiment and the modifications have been described citing the example in which the solenoid 33 is used as the damping force variable actuator of the shock absorber 1, i.e., the pilot valve member 32 forming the pilot valve of the damping force adjustment valve 18 is set as the target driven by the solenoid 33. However, without being limited thereto, the solenoid can be widely used as an actuator built in various kinds of mechanical apparatuses such as a valve used for a hydraulic circuit, i.e., a driving apparatus that drives a driving target that should be linearly driven.

The embodiment and the modifications are only an example, and it is apparent that the configurations indicated in the different embodiments and modifications can be partially replaced or combined.

According to the above-described embodiment and/or modifications (hereinafter simply referred to as the “embodiment”), the cover member is formed by pressing a plate-like member having an even thickness. Therefore, the productivity can be improved while the flexibility of the shape of the cover member is ensured. In other words, the embodiment can improve (increase) the yield of the cover member, improve the productivity, reduce the cost, and reduce the control items from the material to the completion while securing the thrust force of the mover compared to a cover member formed by cutting. Further, the cover member can be easily formed even when the pure iron-based soft magnetic material excellent in soft magnetic property is used as the cover member. Therefore, the productivity can be ensured even when the shape of the cover member is complicated to secure the thrust force of the mover. To put it the other way around, the area of a magnetically necessary portion can be secured and a reduction in the thrust force (magnetic saturation) can be prevented while the productivity is ensured. As a result, the embodiment can ensure the performance and improve the productivity of the solenoid, the damping force adjustment mechanism, and the damping force adjustable shock absorber at the same time.

According to the embodiment, the cover member is formed using the plurality of differently shaped members. Therefore, the productivity can be improved while the flexibility of the shape of the cover member is ensured. In other words, the embodiment can improve (increase) the yield of the cover member, improve the productivity, reduce the cost, and reduce the control items from the material to the completion while securing the thrust force of the mover compared to a cover member formed by cutting. Further, the cover member can be easily formed even when the pure iron-based soft magnetic material excellent in soft magnetic property is used as the cover member. Therefore, the productivity can be ensured even when the shape of the cover member is complicated to secure the thrust force of the mover. To put it the other way around, the area of a magnetically necessary portion can be secured and a reduction in the thrust force (magnetic saturation) can be prevented while the productivity is ensured. As a result, the embodiment can ensure the performance and improve the productivity of the solenoid, the damping force adjustment mechanism, and the damping force adjustable shock absorber at the same time.

According to the embodiment, the cover member includes the first plate-like member having an even thickness, and the second plate-like member located closer to the coil side than the first plate-like member is and disposed so as to overlap the first plate-like member. The second plate-like member is smaller in area than the first plate-like member. Due to that, the second plate-like member can be arranged at a portion where magnetic saturation occurs. Therefore, the cover member can be easily formed while the thrust force of the mover is secured with the aid of the first plate-like member and the second plate-like member.

According to the embodiment, the cover member includes the cylindrical portion provided between the coil and the containing member. Therefore, the magnetic circuit can be established by the cylindrical portion. As a result, the productivity can be improved while the magnetic circuit is optimized.

According to the embodiment, the outer diameter of the containing member includes the small-diameter portion, the large-diameter portion, and the stepped portion between the small-diameter portion and the large-diameter portion. Along therewith, the cylindrical portion of the cover member is press-fitted to the small-diameter portion. Due to that, the containing member can be prevented from rattling from the cover member. Further, the seal member is provided between the stepped portion of the containing member and the cylindrical portion of the cover member. Due to that, the space between the containing member and the cover member can be closed by the seal member. As a result, entry of moisture (water) such as rainwater or mud water from outside can be prevented.

According to the embodiment, the cover member is configured in such a manner that the cylindrical portion and the portion other than the cylindrical portion are formed integrally or separately. Due to that, the cover member can be constituted by one component with the cylindrical portion integrally formed, or two components (or more components) with the cylindrical portion formed separately.

According to the embodiment, the cover member is placed on the stepped portion of the case member, and is fixed to the case member by crimping the large-diameter portion of the case member to the cover member. Therefore, the cover member can be fixed to the case member with an axial space secured between the cover member and the containing member. Accordingly, even when a load is imposed on the cover member, this load can be prevented from being applied to the containing member. As a result, an excessive force can be prevented from being applied to the containing member, and thus the durability and the impact resistance can be improved.

According to the embodiment, the cover member covers the opposite axial end side of the containing member, or the opposite axial end side of the containing member is inserted through the cover member. Therefore, in the case where the cover member covers the opposite axial end side of the containing member, the containing member can be protected by the cover member. On the other hand, in the case where the opposite axial end side of the containing member is inserted through the cover member, the containing member can be exposed from the cover member.

The present invention shall not be limited to the above-described embodiment, and includes various modifications. For example, the above-described embodiment has been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2022-094354 filed on Jun. 10, 2022. The entire disclosure of Japanese Patent Application No. 2022-094354 filed on Jun. 10, 2022 including the specification, the claims, the drawings, and the abstract is incorporated herein by reference in its entirety.

### REFERENCE SIGNS LIST

1 shock absorber (damping force adjustable shock absorber)
2 outer tube (cylinder)
4 inner tube (cylinder)
5 piston
8 piston rod
17 damping force adjustment mechanism
18 damping force adjustment valve
32 pilot valve member (control valve)
33 solenoid
34A coil
36 housing (containing member)
36A containing tubular portion (large-diameter portion)
36B cover portion (small-diameter portion)
36D stepped portion
39 yoke (case member)
39H opposite-side tubular portion (case member)
39H1 large-diameter portion
39H2 small-diameter portion
39H3 stepped portion
41 anchor (stator)
48 armature (mover)
51, 61, 62, 66, 69, 72, 74 cover member
51A cylindrical portion
52, 63, 67, 70 first member
53, 64, 68, 71, 73 second member
53A, 61A, 73A, 74A cylindrical portion (cylindrically-shaped portion)
54 O-ring (seal member)

1. A solenoid comprising:
a coil wound annularly and configured to generate a magnetic force in reaction to power supply;
a mover provided movably in a direction of a winding axis of the coil, the mover being made of a magnetic body;
a stator provided on one side in a movement direction of the mover;
a containing member containing the mover therein and opened on one axial end side; and
a cover member configured to establish a magnetic circuit, the cover member covering the coil,
wherein the cover member is formed by pressing a plate-like member having an even thickness.

2. A solenoid comprising:
a coil wound annularly and configured to generate a magnetic force in reaction to power supply;
a mover provided movably in a direction of a winding axis of the coil, the mover being made of a magnetic body;
a stator provided on one side in a movement direction of the mover;
a containing member containing the mover therein and opened on one axial end side; and
a cover member configured to establish a magnetic circuit, the cover member covering the coil,
wherein the cover member is formed using a plurality of differently shaped members.

3. The solenoid according to claim 1, wherein the plate-like member includes
a first plate-like member having an even thickness, and
a second plate-like member located closer to the coil side than the first plate-like member is, the second plate-like member being disposed so as to overlap the first plate-like member, the second plate-like member being smaller in area than the first plate-like member.

4. The solenoid according to claim 2, wherein the plurality of members includes
a first plate-like member having an even thickness, and
a second plate-like member located closer to the coil side than the first plate-like member is, the second plate-like member being disposed so as to overlap the first plate-like member, the second plate-like member being smaller in area than the first plate-like member.

5. The solenoid according to claim 1, wherein the cover member includes a cylindrical portion provided between the coil and the containing member.

6. The solenoid according to claim 5, wherein an outer diameter of the containing member includes a large-diameter portion and a small-diameter portion,
wherein the cylindrical portion is press-fitted to the small-diameter portion, and
wherein a seal member is provided between a stepped portion and the cylindrical portion, the stepped portion being located between the small-diameter portion and the large-diameter portion.

7. The solenoid according to claim 5, wherein the cover member is configured in such a manner that the cylindrical portion and a portion other than the cylindrical portion are formed integrally or separately.

8. The solenoid according to claim 1, further comprising a case member covering an outer periphery of the coil,
wherein a large-diameter portion and a small-diameter portion connected to the large-diameter portion are formed on one end of an inner periphery of the case member,
wherein the cover member is placed on a stepped portion defined by the large-diameter portion and the small-diameter portion, and
wherein the cover member is fixed to the case member by crimping the large-diameter portion to the cover member.

9. The solenoid according to claim 1, wherein the cover member covers an opposite axial end side of the containing member, or the opposite axial end side of the containing member is inserted through the cover member.

10. A damping force adjustment mechanism comprising:
a coil wound annularly and configured to generate a magnetic force in reaction to power supply;
a mover provided movably in a direction of a winding axis of the coil, the mover being made of a magnetic body;
a stator provided on one side in a movement direction of the mover;
a containing member containing the mover therein and opened on one axial end side;
a cover member configured to establish a magnetic circuit, the cover member covering the coil; and
a control valve configured to be controlled according to an axial movement of the mover,
wherein the cover member is formed by pressing a plate-like member having an even thickness.

11. A damping force adjustment mechanism comprising:
a coil wound annularly and configured to generate a magnetic force in reaction to power supply;
a mover provided movably in a direction of a winding axis of the coil, the mover being made of a magnetic body;
a stator provided on one side in a movement direction of the mover;
a containing member containing the mover therein and opened on one axial end side;
a cover member configured to establish a magnetic circuit, the cover member covering the coil; and
a control valve configured to be controlled according to an axial movement of the mover,
wherein the cover member is formed using a plurality of differently shaped members.

12. A damping force adjustable shock absorber comprising:
a cylinder sealingly containing hydraulic fluid therein;
a piston inserted in the cylinder and dividing an inside of the cylinder into a rod-side chamber and a bottom-side chamber;
a piston rod having one side coupled with the piston and an opposite side extending out of the cylinder;
a flow passage in which a flow of the hydraulic fluid is generated due to extension or compression of the piston rod; and
a damping force adjustment valve provided in the flow passage and configured to be driven by a solenoid,
the solenoid including
a coil wound annularly and configured to generate a magnetic force in reaction to power supply,
a mover provided movably in a direction of a winding axis of the coil, the mover being made of a magnetic body,
a stator provided on one side in a movement direction of the mover,
a containing member containing the mover therein and opened on one axial end side, and
a cover member configured to establish a magnetic circuit, the cover member covering the coil,
wherein the cover member is formed by pressing a plate-like member having an even thickness.

13. A damping force adjustable shock absorber comprising:
a cylinder sealingly containing hydraulic fluid therein;
a piston inserted in the cylinder and dividing an inside of the cylinder into a rod-side chamber and a bottom-side chamber;
a piston rod having one side coupled with the piston and an opposite side extending out of the cylinder;
a flow passage in which a flow of the hydraulic fluid is generated due to extension or compression of the piston rod; and
a damping force adjustment valve provided in the flow passage and configured to be driven by a solenoid,
the solenoid including
a coil wound annularly and configured to generate a magnetic force in reaction to power supply,
a mover provided movably in a direction of a winding axis of the coil, the mover being made of a magnetic body,
a stator provided on one side in a movement direction of the mover,
a containing member containing the mover therein and opened on one axial end side, and
a cover member configured to establish a magnetic circuit, the cover member covering the coil,
wherein the cover member is formed using a plurality of differently shaped members.

14. The solenoid according to claim 2, wherein the cover member includes a cylindrical portion provided between the coil and the containing member.

15. The solenoid according to claim 2, further comprising a case member covering an outer periphery of the coil,
wherein a large-diameter portion and a small-diameter portion connected to the large-diameter portion are formed on one end of an inner periphery of the case member,
wherein the cover member is placed on a stepped portion defined by the large-diameter portion and the small-diameter portion, and
wherein the cover member is fixed to the case member by crimping the large-diameter portion to the cover member.

16. The solenoid according to claim 2, wherein the cover member covers an opposite axial end side of the containing member, or the opposite axial end side of the containing member is inserted through the cover member.
